(19) United States
(12) Patent Application Publication
(10) Pub. No.: US 2023/0373668 A1
(43) Pub. Date: Nov. 23, 2023

(54) Battery System For Portable Docking Stations Of Unmanned Aerial Vehicles

(71) Applicant: Skydio, Inc., San Mateo, CA (US)

(72) Inventors: Yevgeniy Kozlenko, Mountain View, CA (US); Benjamin Scott Thompson, San Carlos, CA (US); Jack Zi Qi Ye, Cupertino, CA (US); Christopher Brian Grasberger, Burlingame, CA (US); Gareth Benoit Cross, San Carlos, CA (US); Jack Louis Zhu, San Mateo, CA (US); Abraham Galton Bachrach, Emerald Hills, CA (US); Adam Parker Bry, Redwood City, CA (US); Hayk Martirosyan, San Francisco, CA (US)

(21) Appl. No.: 18/318,434

(22) Filed: May 16, 2023

Related U.S. Application Data
(60) Provisional application No. 63/342,916, filed on May 17, 2022.

(51) Int. Cl. B64U 80/25; B64U 50/30; B64U 70/92

(52) U.S. Cl. CPC B64U 80/25; B64U 50/30; B64U 70/92; B64U 70/95

(57) ABSTRACT

A battery configured to power an unmanned aerial vehicle. The battery includes an enclosure configured to house a power module of the battery. The battery also includes one or more conducting contacts located on the enclosure configured to contact one or more pogo pins of a battery charger located on a docking station of the unmanned aerial vehicle.

### CROSS-REFERENCE TO RELATED APPLICATION(S)

This application claims priority to and the benefit of U.S. Provisional Patent Application Ser. No. 63/342,916, filed May 17, 2022, the entire disclosure of which is hereby incorporated by reference.

### TECHNICAL FIELD

This disclosure relates to a battery for an unmanned aerial vehicle (UAV), and more specifically, to a battery for a UAV that is configured for automated docking, charging, and storage of a UAV.

### BACKGROUND

Known dock assemblies for UAVs are often large, heavily weighted, mechanically complex, expensive, or a combination thereof. As a result, conventional dock assemblies for UAVs may often be difficult to position within a building or other structure for proper docking of the UAVs or may be challenging to move once positioned.

### SUMMARY

In one aspect of the present disclosure, a battery is disclosed. The battery is configured to removably engage an unmanned aerial vehicle. The battery comprises an enclosure, one or more power modules, one or more light emitting diodes, and one or more conducting contacts. The enclosure includes an upper portion configured to magnetically couple to the underside of the unmanned aerial vehicle and a lower portion coupled to the upper portion and configured to contact a landing surface of a docking station of the unmanned aerial vehicle. The enclosure also includes an interior space formed and at least partially surrounded by the upper portion and the lower portion. The lower portion is complimentary in shape to the landing surface. The one or more power modules are arranged substantially within the interior space. The one or more light emitting diodes are disposed on the enclosure and configured to visually indicate a status of the unmanned aerial vehicle, the battery, or both. Additionally, the one or more conducting contacts are disposed on the lower portion of the enclosure and configured to compressibly engage one or more pogo pins of the docking station to charge the one or more power modules.

In certain configurations, the one or more conducting contacts may be configured to contact and compress the one or more pogo pins of the docking station when the unmanned aerial vehicle is docked on the docking station.

In certain configurations, the one or more conducting contacts may be substantially flush with an exterior surface of the lower portion of the enclosure and may extend through the enclosure into the interior space to couple directly or indirectly with the one or more power modules.

In certain configurations, the one or more conducting contacts may be located in apertures of the lower portion and the one or more conducting contacts may extend through the apertures to contact a printed circuit board assembly disposed in the interior space of the enclosure.

In another aspect of the present disclosure, a system is disclosed. The system includes an unmanned aerial vehicle and a docking station. The unmanned aerial vehicle includes a propulsion mechanism and a battery coupled to a bottom portion of the unmanned aerial vehicle. The battery includes one or more conducting contacts extending through an enclosure of the battery. Additionally, the docking station includes one or more pogo pins configured to contact the one or more conducting contacts of the battery to charge the battery when the unmanned aerial vehicle is docked on the docking station.

In certain configurations, the one or more conducting contacts may be configured to compressibly engage the one or more pogo pins of the docking station to establish an electrical connection between the battery and a battery charger disposed in an interior space of the docking station.

In certain configurations, the one or more pogo pins may be located on a landing surface of the docking station and the one or more conducting contacts may be located on a portion of the enclosure of the battery that may be configured to contact the landing surface.

In certain configurations, the one or more conducting contacts may be located within apertures of the enclosure extending through a thickness of a wall of the enclosure and the one or more conducting contacts may be substantially flush with an exterior surface of the enclosure. The one or more conducting contacts may include at least one substantially linear array of conducting contacts disposed in at least one substantially linear array of apertures of the enclosure.

In certain configurations, the enclosure of the battery may include an upper portion and a lower portion. The upper portion may have a contact surface configured to contact the unmanned aerial vehicle and magnetically couple to an underside of the unmanned aerial vehicle. The lower portion may be coupled to the upper portion and have a bottom surface configured to contact the docking station. The one or more conducting contacts may be located on the bottom surface. The bottom surface of the lower portion may be substantially parallel to the contact surface of the upper portion. The lower portion may be complimentary in shape to a landing surface of the docking station. Additionally, the upper portion may include an engagement region configured to mechanically and electrically engage the unmanned aerial vehicle to transfer power from the battery to the unmanned aerial vehicle.

In certain configurations, the battery may include a control disposed along an exterior surface of the enclosure. The control may be electrically coupled to the one or more power modules located within the enclosure of the battery. The battery may include a light configured to visually indicate a status of the unmanned aerial vehicle, the battery, or both. The light may be disposed on the exterior surface of the enclosure adjacent to the control.

In certain configurations, the enclosure may form an interior space of the battery that houses one or more power modules configured to power the unmanned aerial vehicle and the one or more power modules may be configured to electrically couple with a battery charger of the docking station via the one or more conducting contacts contacting the one or more pogo pins.

In certain configurations, the enclosure may include a substantially planar surface configured to contact a substantially planar landing surface of the docking station when the unmanned aerial vehicle is docked on the docking station. The one or more conducting contacts may be disposed on the substantially planar surface of the enclosure along a longitudinal axis of the battery.

In certain configurations, the one or more conducting contacts may be coupled to a printed circuit board assembly that is disposed in an interior cavity of the enclosure and mounted to an interior surface of the enclosure. The printed circuit board assembly may be electrically coupled to one or more power modules disposed in the interior cavity and the printed circuit board assembly may be electrically coupled to a control of the battery configured to control a state of the battery. Additionally, the printed circuit board assembly may be electrically coupled to one or more light emitting diodes of the battery that are configured to receive power from the one or more power modules and visually indicate a status of the battery.

In another aspect of the present disclosure, a battery is disclosed. The battery is configured to power an unmanned aerial vehicle. The battery includes an enclosure configured to house a power module of the battery and one or more conducting contacts located on the enclosure configured to contact one or more pogo pins of a battery charger located on a docking station of the unmanned aerial vehicle.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a perspective view of an exemplary docking station for facilitating landing of an unmanned aerial vehicle.

FIG. 2 is a perspective view of a dock assembly for an unmanned aerial vehicle.

FIG. 3 is an exploded view of the dock assembly of FIG. 2.

FIG. 4 is a perspective view of a dock assembly for an unmanned aerial vehicle.

FIG. 5 is an exploded view of the dock assembly of FIG. 4.

FIG. 6A is a bottom perspective view of a lower member of a mounting bracket for a docking station of an unmanned aerial vehicle.

FIG. 6B is a top perspective view of the lower member of FIG. 6A.

FIG. 7A is a top perspective view of an upper member of a mounting bracket for a docking station of an unmanned aerial vehicle.

FIG. 7B is a bottom perspective view of the upper member of FIG. 7A.

FIG. 8 is a bottom view of an exemplary docking station for an unmanned aerial vehicle.

FIG. 9 is a perspective view of a power adapter of a docking station for an unmanned aerial vehicle.

FIG. 10 is a perspective view of an exemplary dock assembly for an unmanned aerial vehicle.

FIG. 11 is a perspective view of an exemplary dock assembly for an unmanned aerial vehicle.

FIG. 12A is a diagram of a network configuration for an unmanned aerial vehicle.

FIG. 12B is a diagram of a network configuration for a pair of unmanned aerial vehicles.

FIG. 13 is a flowchart of an example of a process for initiating autonomous operation of an unmanned aerial vehicle.

FIG. 14 is a flowchart of an example of a process for initiating autonomous patrol of an unmanned aerial vehicle.

FIG. 15 is a top perspective view of an exemplary battery for an unmanned aerial vehicle.

FIG. 16 is a bottom perspective view of an exemplary battery for an unmanned aerial vehicle.

FIG. 17 is an exploded view of an exemplary battery for an unmanned aerial vehicle.

### DETAILED DESCRIPTION

The present disclosure relates to a dock assembly for use with a UAV. The dock assembly may be configured to support the UAV when the UAV is not operating. The dock assembly may be configured to charge a power source of the UAV. In certain configurations, the dock assembly may be or may include a support assembly for the UAV. For example, the dock assembly may be a support assembly configured to support the UAV (i.e., docking of the UAV). As such, support assembly as used herein may be construed as a dock assembly (with or without a support) unless otherwise stated.

To facilitate docking of the UAV, the dock assembly may include a docking station configure to receive and/or support the UAV. While the docking station may vary in size and/or shape, the docking station may be configured to contact a portion of the UAV. That is, the docking station may be a portion of the dock assembly that interfaces with the UAV.

Conventional dock assemblies or base stations may often be mechanically complex to ensure proper docking of the UAV. Similarly, the conventional dock assemblies may frequently require cumbersome or bulky enclosures that receive the UAV to protect the UAV when not in operation. Additionally, such dock assemblies may frequently require complex wiring to charge a power source of the UAV. Based on the above, the dock assemblies frequently used with UAVs may often be oversized and require a significant area of clearance to properly receive the UAV during landing. Similarly, conventional dock assemblies may be heavy and burdensome due to their complex nature and size. As a result, it may be challenging to try and reposition the dock assemblies once an initial position has been established.

The present teachings provide a dock assembly which addresses the aforementioned challenges. The dock assembly as described herein may advantageously be less complex mechanically, may be lightweight when compared to conventional dock assemblies, may be easily movable, or a combination thereof. Additionally, the dock assembly herein may also facilitate a variety of mounting configurations, as described in further detail below. Moreover, though the dock assembly herein may have improved packaging and a simpler design, functionality of the dock assembly may not be sacrificed. For example, the dock assembly may still provide a secure means for docking the UAV, may charge a power source of the UAV, may facilitate autonomous docking (e.g., landing) of the UAV on the dock assembly, or a combination thereof.

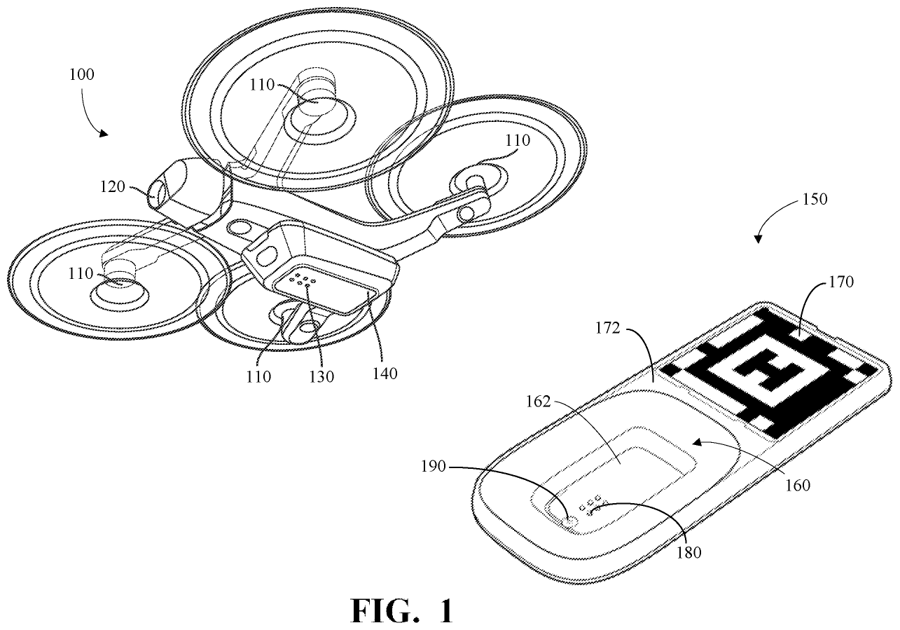

Turning now to the figures, FIG. 1 illustrates a perspective view of an unmanned aerial vehicle (UAV) 100 and a docking station 150 that is configured to support and/or service (e.g., docking, storage, charging, operation, etc.) the UAV 100. While a single UAV 100 and a single docking station 150 are shown and described herein, it is envisioned that a plurality of UAVs 100 and a plurality of docking stations 150 may be utilized. For example, two or more UAVs 100 may be configured to dock on a single docking station 150 or, conversely, a single UAV 100 may be configured to dock on two or more docking stations 150.

The UAV 100 may include one or more propulsion mechanisms (systems) 110 and a power source, such as a battery 140. The UAV 100 may be configured for autonomous landing and docking with the docking station 150. To support the autonomous landing and docking, the UAV 100 may follow any suitable process or procedure and may include any suitable electrical and/or logical components. For example, the UAV 100 may follow processes or procedures, or may include one or more components, such as those described in U.S. Publication Ser. No. 16/991,122, the entire disclosure of which is herein incorporated by reference.

The propulsion mechanism(s) 110 may include any components and/or structures suitable for supporting flight of the UAV 100. For example, as shown in FIG. 1, the propulsion mechanism(s) 110 may be propeller assemblies having one or more blades connected to hubs of the UAV 100. The one or more blades may be powered by a motor (not shown) to rotate the one or more blades and facilitate flight of the UAV 100. It should be appreciated, however, that the configuration and/or structure of the UAV 100 may vary depending on the particular application, and as such, the UAV 100 shown in FIG. 1 is not intended to limit the structure of the UAV 100. That is, the docking station 150 as described herein may be adapted for use with a variety of UAV 100 structures.

The docking station 150 may be configured to receive and/or support the UAV 100. The docking station 150 may include a landing surface 160 configured to receive a portion of the UAV 100 during landing of the UAV 100 on the docking station 150. For example, as shown in FIG. 1, the docking station 150 may include a tapered or funneled shape converging towards a base region of the landing surface 160. A bottom portion or surface of the UAV 100, such as a portion of the battery 140, may be configured to abut the landing surface 160. As a result, the landing surface 160 may beneficially guide a shape of the battery 140 so that the plurality of conducting contacts 130 located on an exterior, bottom surface of the battery 140 may align with the plurality of conducting contacts 180 located on the base region of the landing surface 160. Therefore, once the UAV 100 has landed (e.g., docked) on the landing surface 160, the battery 140 of the UAV 100 may be charged by a battery charger located within the docking station 150 via the conducting contacts 130, 180.

The conducting contacts 180 of the docking station 150 may be complimentary in shape to the conducting contacts 130 of the UAV 100. The conducting contacts 180 may extend through a surface of the docking station, such as the landing surface 160, to contact the conducting contacts 130 of the UAV 100. The conducting contacts 180 may be substantially flush with, or recessed from, a surface of the docking station 150 (e.g., the landing surface 160). While the conducting contacts 180 are illustrated as being located on the base 162 of the landing surface 160, it is envisioned that the conducting contacts 180 may be disposed anywhere along the docking station 150. For example, the conducting contacts 180 may be located on a tapered region of the landing surface 160, on a peripheral or top edge of the landing surface 160, or a combination thereof.

The conducting contacts 180 may be structurally rigid or may be flexible. The conducting contacts 180 may move when contacted by the conducting contacts 130 of the UAV 100. For example, the conducting contacts 180 may be compressed by the conducting contacts 130 of the UAV 100 when the UAV 100 is docked. The conducting contacts 180 may compress to engage internal circuitry of the docking station 150, such as a printed circuit board assembly (PCBA) located within the docking station 150. As a result, when the conducting contacts 180 are compressed, a portion of the conducting contacts 180 located within the docking station 150 may engage the internal circuitry to create an electrical connection between the battery 140 and the battery charger within the docking station 150, thereby facilitating charging of the battery 140.

It should be noted that a size and/or shape of the conducting contacts 180 may not be limited to any one structure and may vary based upon the configuration desired. For example, as mentioned above, if compressible engagement between the conducting contacts 180 and the conducting contacts 130 of the battery 140 are desired, the conducting contacts 180 may be a pogo pin structure.

The pogo pin structure may facilitate a first portion of the conducting contacts 180 compressing or otherwise moving relative to a second portion of the conducting contacts 180. The pogo pin structure may be a telescoping structure to allow for such compression. For example, the pogo pin structure may include a movable plunger coupled to a barrel. The pogo pin structure may include one or more biasing members (e.g., a spring or elastic member) that may be compressed when the pogo pin is compressed by the UAV 100. When the UAV 100 releases engagement with the pogo pin, the one or more biasing members may then return the pogo pin to an original, uncompressed position. As a result, the pogo pin structure may provide a means to decrease damage or distress (e.g., shearing, bending, breaking, etc.) on the conducting contacts 180 caused by contact with the conducting contacts 130 when the UAV 100 docks, thereby increasing a service life of the conducting contacts 180. It is also worth noting that, while the pogo pin structure has been described herein with respect to the conducting contacts 180 of the docking station 150, such structure may also be utilized for the conducting contacts 130 of the UAV 100 in certain configurations.

While the pogo pin structure of the conducting contacts 180 has been described above, it is envisioned that in certain configurations, the battery 140 may be charged by the docking station 150 in other manners. Charging of the battery 140 may be accomplished via direct contact between the battery 140 and the battery charger within the docking station 150, such as by utilizing the pogo pin structure or other structure for the conducting contacts 180. Alternatively, or additionally, charging of the battery 140 may be accomplished free of the conducting contacts 130, 180. For example, charging of the battery 140 may be inductive charging, whereby the battery 140 may be disposed on the docking station 150 so that one or more coils located in the docking station 150 may wirelessly charge the battery 140 in an inductive manner. Charging of the battery 140 may also be accomplished in a contactless manner. For example, the docking station 150 may include one or more antennas configured to wireless transmit power to the battery 140. Similarly, the docking station 150 may include a transmitter configured to distribute ultrasound waves that may transmit power to the battery 140. As such, one skilled in the art may glean from the present teachings that communication between the battery 140 and the docking station 150 (or a battery charger therein) may vary. Furthermore, any feature described above with respect to docking station 150 for charging may also be incorporated into the battery 140.

Though the landing surface 160 may be tapered and include a substantially rectangular base region as shown in FIG. 1, it should be noted that a geometry of the landing surface 160 may vary. For example, the landing surface 160 may vary in shape based upon a shape of a bottom region of the UAV 100 (e.g., a shape of the battery 140). As such, it is envisioned that a shape of the landing surface 160 may be shaped or otherwise adapted to support the UAV 100 and ensure proper contact between the conducting contacts 180 of the landing surface 160 and the conducting contacts 130 of the battery 140.

To ensure proper contact between the conducting contacts 130, 180, the landing surface 160 may be complimentary in shape to the battery 140 (as shown in FIG. 1) or may use one or more additional mechanical guides to properly align the UAV 100 with the landing surface 160. For example, the landing surface 160 may be substantially planar and include one or more projections or biasing members (e.g., spring, elastic member, etc.) configured to properly position the UAV 100 during landing. Thus, one skilled in the art may glean from the present teachings that the landing surface 160 may vary based upon various configurations of the UAV 100. For example, in certain configurations, the conducting contacts 180 of the landing surface 160 may be located on a side face of the or other location of the landing surface other than the base region.

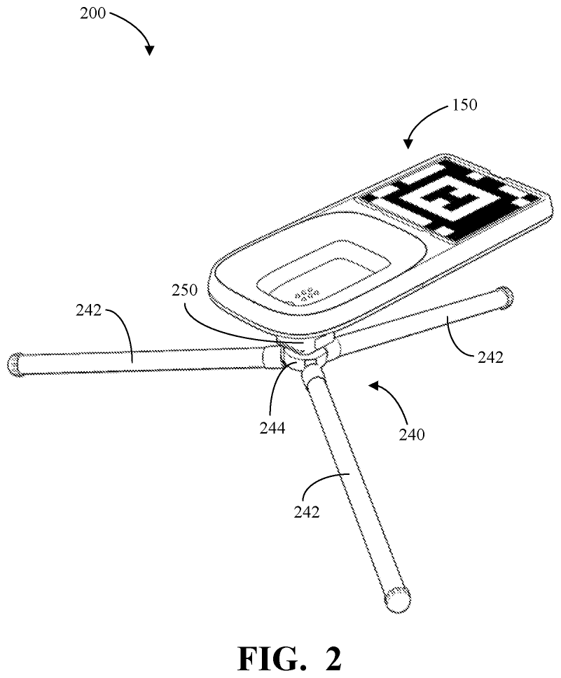

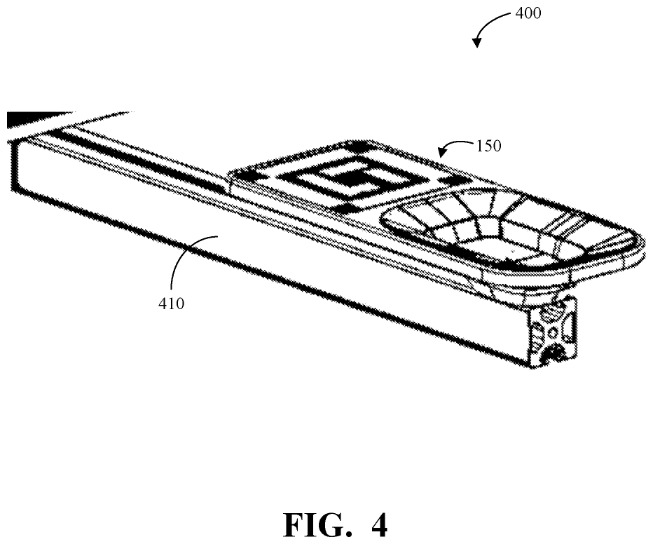

Though not shown in FIG. 1, as described in further detail below with respect to FIGS. 2 and 4, the docking station 150 may be configured for mounting to a support or stand. As a result, the docking station 150 in conjunction with the support or stand may provide proper support for the UAV 100 to dock and remain stationary in a desired position. However, in certain configurations, the docking station 150 may be self-standing or include an integrated support or stand to facilitate docking of the UAV 100. For example, the docking station 150 may include a base column or pillar extending from a bottom of the docking station 150 to maintain a position of the docking station 150.

Advantageously, the docking station 150 may be adapted for mobility and repositioning as needed. That is, in certain embodiments, the docking station 150 may be easily moved from an initial location to one or more additional locations. For example, the UAV 100 may be configured to scan or otherwise monitor a first building, in which the docking station 150 may be positioned in the first building to allow for flight and landing of the UAV 100. Once the UAV 100 completes the scan or monitoring of the first building, the UAV 100 and the docking station 150 may be moved to a second building for additional scanning or monitoring without time-consuming installation of the docking station 150. During such movement, the docking station 150 may be easily repositioned due at least in part to a level bubble 190 integrated into the landing surface 160. As a result, a user of the docking station 150 may adjust a position of the landing surface 160—either directly or indirectly as described below—until the level bubble 190 indicates that the landing surface 160 is level and ready to receive the UAV 100. Thus, based on the above, the UAV 100 and the docking station 150 may beneficially provide an easily transportable system.

The landing surface 160 may be formed or otherwise coupled to an extended portion 172 of the docking station 150. The extended portion 172 may be a surface or area of the docking station 150 that extends from, or otherwise projects from, the landing surface 160. The extended portion 172 may include a cutout or receiving portion that facilitates connection to the landing surface 160. That is, the landing surface 160 may be a separate component mechanically or adhesively connected to the extended portion 172 to at least partially form the docking station 150. However, it is envisioned that in certain configurations the landing surface 160 and the extended portion 172 may be integrally (i.e., monolithically) formed as a single piece, such as through injection molding or a similar manufacturing process.

The extended portion 172 may provide a surface of the docking station 150 that is positioned adjacent to, and free of contact with, the landing surface 160. As a result, the UAV 100 may dock on the landing surface 160 without contacting the extended portion 172. However, in certain configurations, a portion of the UAV 100 may contact the extended portion 172, such as for further stability when docked.

The UAV 100 may be configured using various processes or protocols to autonomously land on the landing surface 160. To facilitate autonomous landing (e.g., docking) of the UAV 100, the UAV 100 may include an image sensor 120 configurated to monitor a position of the UAV 100 and/or detect a specified image, such as the fiducial 170. As shown in FIG. 1, the fiducial 170 may be disposed on an upper surface of the extended portion 172 and located adjacent to the landing surface 160. An upper surface of the extended portion 172 may be a visible topmost surface of the extended portion 172 easily viewed by the UAV 100 during flight. During a landing sequence (e.g., docking sequence) of the UAV 100, the image sensor 120 of the UAV may detect the fiducial 170 to properly align and guide the UAV 100 to dock on the landing surface 160. Beneficially, the fiducial 170 may provide a marker to guide the UAV 100, yet the fiducial 170 may not obstruct the landing surface 160. That is, the fiducial 170 may be positioned adjacent to, and free of contact with, the landing surface 160. As a result, a risk of degradation (e.g., scratching, chipping, abrasion, fading, etc.) of the fiducial 170 that may be caused by contact with the UAV 10 during landing can be prevented.

A size and/or shape of the fiducial 170 may vary depending on the size and/or shape of the extended portion 172. However, it is envisioned that an area of the fiducial 170 may be optimized for the upper surface of the extended portion 172. In other words, an area of the fiducial may be substantially the same as an area of the extended portion 172 to provide an easily identifiable marker for the image sensor 120 of the UAV 100 to capture.

In addition to the fiducial 170 being positioned adjacent to the landing surface 160 of the docking station 150 to avoid obstruction of the landing surface 160, the fiducial 170 may advantageously be disposed on the docking station 150 in a manner that remains visually unobstructed by the UAV 100 during a landing (e.g., docking) operation of the UAV 100. To ensure proper identification of the fiducial 170 by the UAV 100, the fiducial 170 may be disposed on an upper surface of the docking station 150 (as discussed in further detail below) to remain viewable by the UAV 100 without the UAV 100 or other portions of the docking station 150 casting shadows on the fiducial 170 or otherwise distorting the fiducial 170.

FIG. 2 illustrates a perspective view of a dock assembly 200 in accordance with the present teachings. The dock assembly 200 may include a docking station 150 configured to support and/or receive a UAV, such as the UAV 100 shown in FIG. 1.

As described above, the docking station 150 may include a landing surface 160 configured to receive a bottom portion or surface of the UAV 100. Additionally, the docking station 150 may include an extended portion 172 having a fiducial 170 disposed thereon. The fiducial 170 may provide a marker to aid with autonomous landing (e.g., docking) of the UAV 100.

To provide a more portable docking station 150 and facilitate placement of the docking station 150 in a variety of locations, the docking station 150 may be coupled to a stand 240 by a mounting bracket 250. The stand 240 may be configured to support and/or position the docking station 150 (e.g., with aid from the level bubble 190 located on the landing surface 160) to ensure proper contact between the landing surface 160 and the UAV 100. The stand 240 may be adjustable (e.g., tiltable, rotatable, adjustable with respect to an elevation or height of the docking station 150) to properly position the docking station 150 in order to dock the UAV 100. As a result, the stand 240 may facilitate positioning of the docking station 150 in various locations.

The docking station 150 in conjunction with the stand 240 may be configured for positioning along one or more surfaces within a building, such as the floor of the building or on a platform (e.g., shelf, tabletop, chair seat, box, ledge, etc.) Due to the adjustability of the stand 240, the docking station 150 may beneficially be positioned on an uneven surface. For example, the surface may be tilted, may not be level, may include one or more undulations, or a combination thereof. However, the stand 240 may be adjusted to level the docking station 150.

To facilitate the aforementioned adjustment of the stand 240, the stand 240 may include one or more legs 242. As shown, the stand 240 may include three adjustable legs 242 (e.g., a tripod configuration). However, the stand 240 may include any number of legs 242.

The legs 242 may be pivotable with respect to an attachment portion 244 of the stand 240. The attachment portion 244 may be centrally located with respect to the legs 242 and may remain substantially stationary when adjusting (e.g., pivoting) the legs 242. While the legs 242 are illustrated as pivoting with respect to the attachment portion 244 of the stand 240, it should be noted that the legs 242 may also move in other manners with respect to the stand 240. For example, the legs 242 may move laterally (e.g., slide) with respect to the attachment portion 244.

The legs 242 may be vary in length (e.g., as measured from an end coupled to the attachment portion 244 to an opposing end of the legs 242) or the legs 242 may be uniform in length. A length of the legs 242 may be adjustable. For example, the legs 242 may be telescoping or otherwise extendable to modify a length of the legs 242.

It should also be noted that, in certain configurations, the legs 242 may be structurally rigid or otherwise fixated. That is, the legs 242 may be coupled to the stand 240 in a predefined position and maintain the predefine position to maintain a position of the stand 240.

The legs 242 and thus the dock assembly 200 altogether may be freestanding to stand on a surface. That is, the legs 242 may be adjustable as described above yet still support the docking station 150 and maintain a position of the docking station 150 without any additional structures. For example, the legs 242 may have a release mechanism (e.g., clasp, lock, etc.) that allows for tightening and releasing the legs 242 in order to adjust the legs 242. The release mechanism may be loosened to move the legs 242 and, once the legs 242 have been sufficiently adjusted, the release mechanism may be tightened to maintain the position of the legs 242.

To aid with maintaining a position of the stand 240, one or more of the legs 242 may include a friction modifier. The friction modifier may be a foot or stopper disposed near or on an end of the legs 242. The friction modifier may be configured to contact the surface supporting the stand 240 and increase friction between the surface and the legs 242. For example, the friction modifier (e.g., foot or stopper) may be rubberized or may include an adhesive to maintain the position of the stand 240.

Alternatively, or additionally, the stand 240 may be mountable. That is, the stand 240 may be mounted directly or indirectly to the surface supporting the stand 240. The legs 242, the attachment portion 244, or both may be configured for direct fastening to the surface. For example, the legs 242 may include one or more holes to receive a fastener (e.g., screw bolt, rivet, etc.) therethrough, thereby allowing for the fastener to extend through the legs 242 and be fastened into the surface. However, advantageously, the stand 240 may allow for either more permanent or portable positioning of the docking station 150 based upon a user's needs. For example, if the docking station 150 is intended for use in a plurality of locations or buildings, the legs 242 of the docking station 150 may simply be adjusted at each location to ensure proper positioning of the docking station 150. However, if the docking station 150 is intended for a single building and further movement of the docking station 150 is not desired, the legs 242 or other portion of the stand 240 may be more permanently secured to a surface using one or more fasteners.

While the above stand 240 has been described as a tripod configuration, it is envisioned that various other stands 240 may be considered. The stand 240 may be or may include a base member extending from and connected to the docking station 150. The stand 240 may be or may include one or more adjustable feet as opposed to movable legs to accommodate positioning of the docking station 150. As such, it may be gleaned from the present teachings that the structure as described above is not intended to limit various configurations of the stand 240.

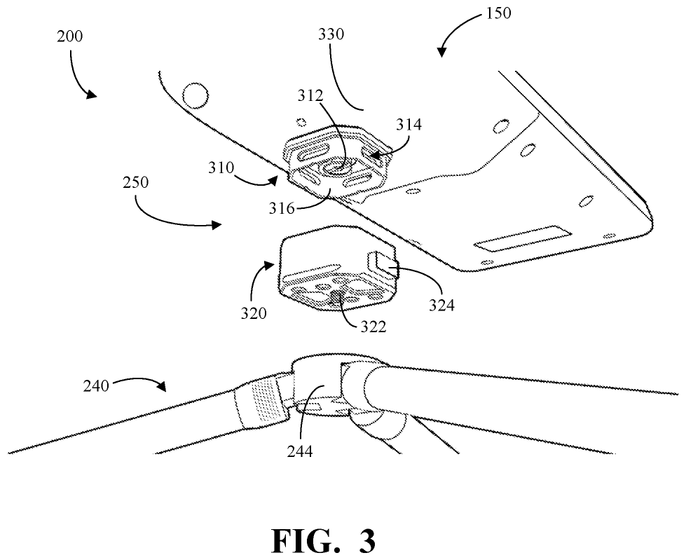

FIG. 3 illustrates an exploded view of the dock assembly 200 shown in FIG. 2. As described above, the docking station 150 may be attached either directly or indirectly to the stand 240.

For direct attachment, the docking station 150 may be secured using one or more fasteners (e.g., screws, bolts, etc.), a quick connect mechanism (e.g., press-fit or friction fit engagement), a male-female connection (e.g., a male portion of the stand 240 may be received by a female portion of the docking station 150), a mechanical joint (e.g., a ball joint), an adhesive, or a combination thereof.

Alternatively, or additionally, the docking station 150 may be secured to the stand 240 by the mounting bracket 250 shown in FIGS. 2 and 3. The mounting bracket 250 may be located between the docking station 150 and the stand 240. The mounting bracket 250 may provide an intermediary such that the docking station 150 is free of direct contact with the stand 240. However, contact between the docking station 150 and the stand 240 in certain configurations may be desired.

The mounting bracket 250 may include an upper member 310. The upper member 310 may be configured to attach to the docking station 150. The upper member 310 may be secured to any portion of the docking station 150. However, as shown, it is envisioned that the upper member 310 may be secured to a bottom surface of the docking station 150, such as an outer surface of an enclosure 330 of the docking station 150. As described below, the enclosure 330 may be configured to house one or more components used to charge the battery 140 of the UAV 100.

The upper member 310 may be secured to the docking station 150 by one or more fasteners 312, such as a screw or bolt. The fastener(s) 312 may align and extend into a hole of the docking station 150 to secure the upper member 310 to the docking station 150. However, it is envisioned that any mounting technique may be utilized to secure the upper member 310. In certain circumstances, as described below, the upper member 310 may also include an alignment feature to ensure proper alignment between the upper member 310 and the docking station 150.

The upper member 310 may include one or more walls 316 extending from a base portion of the upper member 310. The base portion of the upper member may be a portion of the upper member 310 that abuts or otherwise contacts the docking station 150. The wall(s) 316 may project from the base portion in a direction away from the docking station 150. A height of the wall(s) 316 as measured from the base portion to an opposing terminal end of the wall may vary.

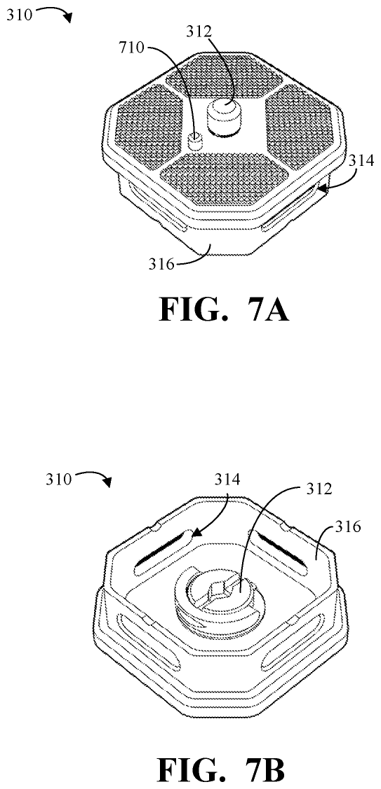

The wall(s) 316 may include one or more apertures 314. The aperture(s) 314 may be a slot, hole, cutout, or a combination thereof. The aperture(s) 314 may be uniform or may vary in size and dimensions. Each wall 316 may include an aperture 314 or a portion of the walls 316 may be free of any aperture 314. As such, any number of apertures 314 may be located on the upper member 310. The aperture(s) 314 may be configured to engage a portion of a lower member 320 of the mounting bracket 250. For example, a clasp or latch of the mounting bracket 250 may be received in the aperture(s) 314 to secure the lower member 320 to the upper member 310 (see, e.g., FIG. 7B).

The lower member 320 may be configured for mounting to the stand 240. The lower member 320 may be secured to the attachment 244 portion of the stand 240 or may be connected to another portion of the stand 240, such as one or more of the legs 242. However, it is envisioned that the lower member 320 may be secured to the stand 240 in a manner that allows adjustable portions of the stand 240 (e.g., the legs 242) to freely move without obstruction from the lower member 320.

The lower member 320 may be secured to the stand 240 using one or more fasteners 322. The fastener(s) 322 may be similar or different to the fastener(s) 312 described above. As such, the lower member 320 may be secured to the stand 240 in a similar or different manner to securement of the upper member 310 to the docking station 150.

As described above, the lower member 320 may include an engaging portion (e.g., clasp or latch) that engages the upper member 310 (e.g., the aperture(s) 314 of the upper member 310). Advantageously, the lower member 320 may include a button 324 in communication with the engaging portion of the lower member 320 so that, when the button 324 is pressed, the engaging portion of the lower member 320 may disengage the upper member 310. As a result, the docking station 150 may be releasable engaged to the stand 240 by the mounting bracket 250 to facilitate quick and easy connection and disconnection of the docking station 150 and the stand 240.

FIG. 4 illustrates a perspective view of another dock assembly 400. As described above with respect to FIGS. 2 and 3, the docking station 150 may be secured to a stand 240 for freestanding support of the docking station 150. Alternatively, or additionally, the docking station 150 may also be configured for attachment to a mount 410. As a result, the docking station 150 may be further customizable to provide positioning in locations that may otherwise not be possible with freestanding support using the stand 240.

The mount 410 may be configured to support the docking station 150 and maintain a position of the docking station 150 for use with the UAV 100, similar to the support provided by the stand 240. However, the mount 410 may also be configured to secure the docking station 150 to an additional structure. The mount 410 may be configured to secure the docking station 150 to one or more surfaces of a building, such as a wall or ceiling of the building. The mount 410 may be configured to secure the docking station 150 to a shelving unit or storage rack unit. For example, the mount 410 may be secured to a shelf of the shelving unit or storage rack unit, may be secured to a vertical or horizontal support of the shelving unit or storage unit, or a combination thereof.

Advantageously, the mount 410 may be configured for mounting to any number of surfaces or structures based on the desired needs and use of the UAV 100. The mount 410 may be mounted along a portion of the shelving unit or storage unit described above so that the docking station 150 may be positioned away from potential hazards. For example, if the UAV 100 were to be operating in a warehouse facility or manufacturing plant, the mount 410 may secure the docking station 150 in a heightened location away from machinery and workers who may accidentally damage or otherwise contact the docking station 150 and/or the UAV 100. Similarly, the mount 410 may also facilitate mounting of the docking station 150 in a location that minimizes floor or surface space needed.

The mount 410 may vary in dimensions and structure. The mount 410, as shown, may be a cantilevered arm or member. In such a manner, the docking station 150 may be mounted to a first end of the mount 410 while an opposing second end of the mount 410 may be secured to a surface or structure. The mount 410 may be any bracket, arm, member, or shaft that may facilitate mounting of the docking station 150 to a surface or structure. For example, the mount 410 may be a pultruded or extruded shaft or beam that may support the docking station 150 and secure the docking station 150 to the surface or the structure.

The mount 410 may be secured to the surface or the structure in any desired means. The mount 410 may be secured using one or more fasteners, one or more adhesives, or both. The mount 410 may be secured using one or more mechanical interlocks (e.g., an eyehole or keyhole of a structure that receives a protrusion of the mount 410 therein, or vice versa). The mount 410 may also be an extension of a structure. For example, the mount 410 may be a member of a shelving unit or storage unit that extends from a central region of the shelving unit or storage unit. In such a case, the mount 410 may be formed integrally with a component or portion of the shelving unit or storage unit.

The mount 410 may be selectable from a plurality of mounts 410. For example, the docking station 150 may be configured for mounting to a variety of mounts 410, whereby a specific mount 410 may be selected based upon mounting needs. That is, a mount 410 selected for mounting the docking station 150 to a wall or ceiling of a building may be a different mount 410 than one used for mounting the docking station 150 to a shelving unit or storage unit. However, it should be gleaned from the present teachings that the mounts 410 described herein are not intended to limit the various structures or surfaces in which the docking station 150 may be secured. Such structures or surfaces may include, but are not limited to: interior building walls and/or ceilings, exterior building walls, shelving units or storage units, racks, doors, furniture (e.g., desk, bookcase, etc.), beams, a roof of a building, a vehicle (e.g., a vehicle cargo box or accessory mounted in the vehicle cargo box), and a pole (e.g., light pole).

All or a portion of the mount 410 may be movable. The mount 410 or a portion of the mount 410 may pivot, rotate, bend, slide, or otherwise move to further position the docking station 150 in a desired location. For example, the mount 410 may pivot so that the docking station 150 may be moved from a stored position, in which the docking station 150 is located adjacent to a surface or structure, to an extend position, in which the docking station 150 is pivoted away from the surface or structure to allow for docking of the UAV 100. In one particular configuration, the mount 410 may operate as described above to provide a drop-down ceiling mount 410 for the UAV 100.

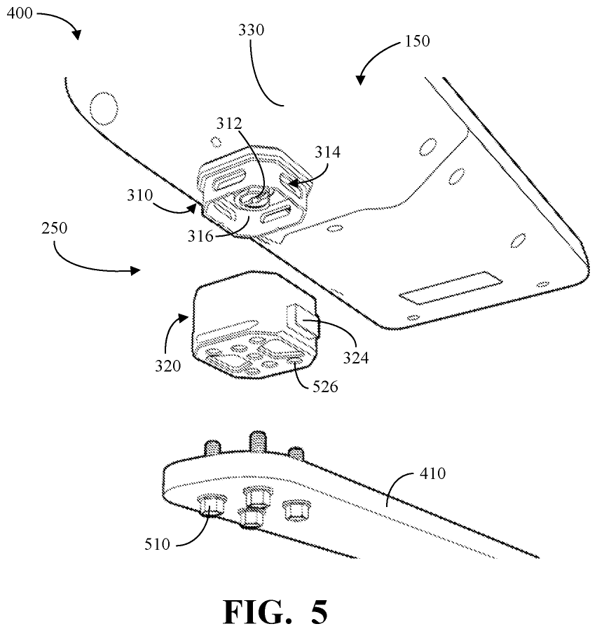

FIG. 5 illustrates an exploded view of the dock assembly 400 of FIG. 4. As described above, the docking station 150 may be attached either directly or indirectly to the mount 410.

For direct attachment, the docking station 150 may be secured using one or more fasteners (e.g., screws, bolts, etc.), a quick connect mechanism (e.g., press-fit or friction fit engagement), a male-female connection (e.g., a male portion of the mount 410 may be received by a female portion of the docking station 150, or vice versa), a mechanical joint (e.g., a ball joint), an adhesive, or a combination thereof.

Alternatively, or additionally, the docking station 150 may be secured to the mount 410 by the mounting bracket 250. Advantageously, the mounting bracket 250 may facilitate mounting of the docking station 150 to both the stand 240 and the mount 410, thereby providing further customization.

As described above with respect to FIG. 3, the mounting bracket 250 may include an upper member 310 and a lower member 320. The upper member 310 may be configured to attach to the docking station 150, such as the enclosure of the docking station 150. The upper member 310 may be secured to the docking station 150 by one or more fasteners 312.

Similarly, the lower member 320 may be configured to attach to the mount 410 by one or more fasteners 510. However, it should be noted that while attachment of the lower member 320 to the stand 240 and the mount 410 may be similar, a fastener configuration may vary to accommodate different geometries. For example, as shown in FIG. 3, the lower member 320 may be secured to the stand 240 by a single fastener 322 extending centrally through the lower member 320 into the stand 240. Conversely, as shown in FIG. 5, the lower member 320 may include a plurality of mounting holes 526 that receive the fasteners 510 of the mount 410, thereby securing the lower member 320 to the mount 410. However, any mounting scheme may be possible.

Additionally, as discussed above with respect to FIG. 3, the upper member 310 may include one or more apertures 314 located on the wall(s) 316 of the upper member 310. The aperture(s) 314 may be configured to engage an engaging portion of the lower member 320, thereby facilitating quick and easy connection and/or disconnection between the lower member 320 and the upper 310, thus also allowing for quick and easy connection and/or disconnection between the docking station 150 and the mount 410.

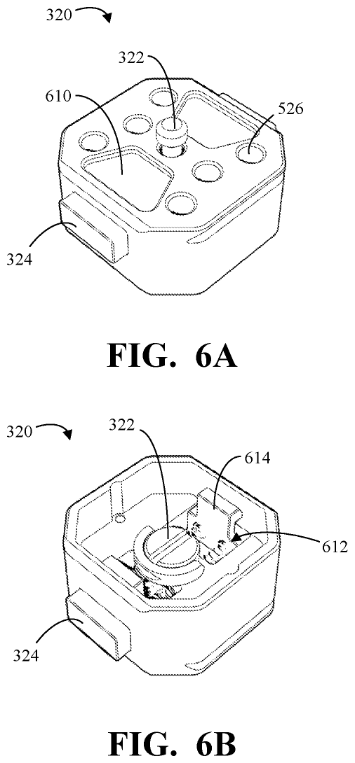

FIGS. 6A and 6B illustrate a bottom perspective view and a top perspective view, respectively, of the lower member 320 of the mounting bracket 250. As described above, the mounting bracket 250 may be configured for mounting the docking station 150 to the stand 240, the mount 410, or both. That is, the mounting bracket 250 may be a universal bracket to attach the docking station 150 to a variety of supports, such as the stand 240 and the mount 410. However, the mounting bracket 250 may be configured for the specific support being used. For example, a first mounting bracket 250 may be configured for mounting the docking station 150 to the stand 240 while a second mounting bracket 250 may be configured for mounting the docking station to the mount 410.

The lower member 320 may include a central fastener 322, such as a pin, bolt, screw, rivet, etc. The central fastener 322 may extend through a portion of the lower member 320 so that the fastener 322 may be received in a hole of the stand 240 or the mount 410. The fastener 322 may be adapted for hand-tightening (e.g., a D-ring screw or bolt, such as that shown in FIG. 6B), may be adapted for tightening with a tool, or both. A head of the fastener 322 may be located within the confines of the lower member 320 to ensure proper engagement between the lower member 320 and the upper member 310.

The lower member 320 may also include one or more recessed portions 610 along a bottom surface of the lower member 320. The bottom surface of the lower member 320 may be a surface configured to contact the stand 240 or the mount 410. The recessed portion(s) 610 may be configured to aid with aligning the lower member 320 and the stand 240 or the mount 410. For example, a protrusion or nub along the stand 240 or the mount 410 may be complimentary in shape to the recessed portion(s) 610 to ensure proper alignment—axially and/or laterally—between the stand 240 or the mount 410 and the lower member 320. In certain embodiments, the recessed portion(s) 610 may be located on the stand 240 or the mount 410 while the protrusion or nub is located on the lower member 320.

The lower member 320 may also include one or more mounting holes 526. As discussed above, the mounting hole(s) 526 may be configured to receive a fastener from the stand 240 or the mount 410, as shown in FIG. 5. The mounting hole(s) 526 may vary in location along the bottom surface of the lower member 320. The mounting hole(s) 526 may also vary in dimensions to accommodate different types of fasteners for different mounting techniques or mounts 410.

The lower member 320 may also include one or more latches 614. As described above, the latch(es) 614 may be configured to engage aperture(s) 314 in the upper member 310. The latch(es) 614 may be a finger, hook, projection, arm, bend, or a combination thereof that may be complimentary in shape to the aperture(s) 314 to engage a peripheral edge of the aperture(s) 314 and connect the lower member 320 to the upper member 310. It should be noted, however, that the latch(es) 614 may in certain configurations be located on the upper member 310 while the aperture(s) 314 are located on the lower member 320.

The latch(es) 614 may be biased to a first position by one or more biasing members 612. The biasing member(s) 612 may be a spring or elastic member that exerts a force on the latch(es) to maintain the first position of the latch(es) 614. The biasing member(s) 612 may also allow for the latch(es) 614 to move when an external force is exerted on the latch(es) 614. For example, it is envisioned that when the latch(es) 614 engage the wall(s) 316 of the aperture(s) 314 of the upper member 310, the latch(es) 614 may move from the first position to one or more secondary positions, in which the biasing member(s) 612 store energy to move the latch(es) 614 back to the first position. Once the latch(es) 614 are positioned within the aperture(s) 314, the biasing member(s) 612 may exert the stored energy onto the latch(es) 614 to move the latch(es) 614 back to or towards their first position, thereby engaging the lower member 320 to the upper member 310.

Once the latch(es) 614 are engaged to the upper member 310, one or more buttons 324 located on an outer wall or outer surface of the lower member 320 may be pressed to move the latch(es) 614 and release the latch(es) 614 from the upper member 310, thereby disengaging the lower member 320 and the upper member 310. Once the button(s) 324 are released, the biasing member(s) 612 may move the latch(es) 614 back to the first position. However, it should be noted that any release mechanism may be used in lieu of the button 324 shown. For example, the release mechanism of the lower member 320 may be a release pin or tab (e.g., pull tab), a clasp, a cord, or other release mechanism.

FIGS. 7A and 7B illustrate a top perspective view and a bottom perspective view, respectively, of the upper member 310 of the mounting bracket 250. As discussed above, the upper member 310 may be configured for mounting to the docking station 150.

The upper member 310 may include a top surface having an alignment pin 710 extending therefrom. The top surface of the upper member 310 may be a surface of the upper member 310 that abuts or otherwise contacts the docking station 150, such as shown in FIGS. 3 and 5. The alignment pin 710 may be configured to align with, and be received by, an opening or hole along the docking station 150. The alignment pin 710 may thus be configured to aid in aligning the upper member 310 with respect to the docking station 150. It should be noted, however, that a size, shape, and/or position of the alignment pin 710 may vary. Similarly, the alignment pin 710 may also project from the docking station 150 and be received by an alignment hole of the upper member 310 in certain embodiments.

A fastener 312, such as a bolt or screw, may extend from a central, interior portion of the upper member 310 through the top surface of the upper member 310. The fastener 312 may be configured to engage a hole along the docking station 150, such as along the enclosure 330 of the docking station 150, once the alignment pin 710 has been aligned with an alignment hole of the docking station 150. The fastener 312 may be the same or different to the fastener 322 of the lower member 320. As such, the fastener 312 may also be manually tightened and/or released or may be tightened using one or more tools.

The top surface of the upper member 310 may include an abrasive surface. The abrasive surface may be configured to increase friction between the top surface of the upper member 310 and the docking station 150, thereby preventing movement (e.g., rotation) of the upper member 310 relative to the docking station 150, or vice versa. The abrasive surface may be disposed along all or a portion of the top surface of the upper member 310. The abrasive surface may be a secondary coating on the top surface, such as a rubberized coating, or may be formed with the upper surface (e.g., knurling).

As discussed above, the upper member 310 may also include one or more apertures 314 located on wall(s) 316 of the upper member 310. The wall(s) 316 may extend generally orthogonally from the top surface or a top region of the upper member 310. However, the wall(s) 316 may extend at any desired angle with respect to the top surface of the upper member 310. The wall(s) 316 may be formed with the top surface as an integral one-piece component or may be connected to the top surface. The wall(s) 316 may be planar, may include curvature, or both. Additionally, as discussed above, the aperture(s) 314 may be shaped and configured to receive a portion of the latches 614 of the lower member 320 to releasably engage the lower member 320 and the upper member 310.

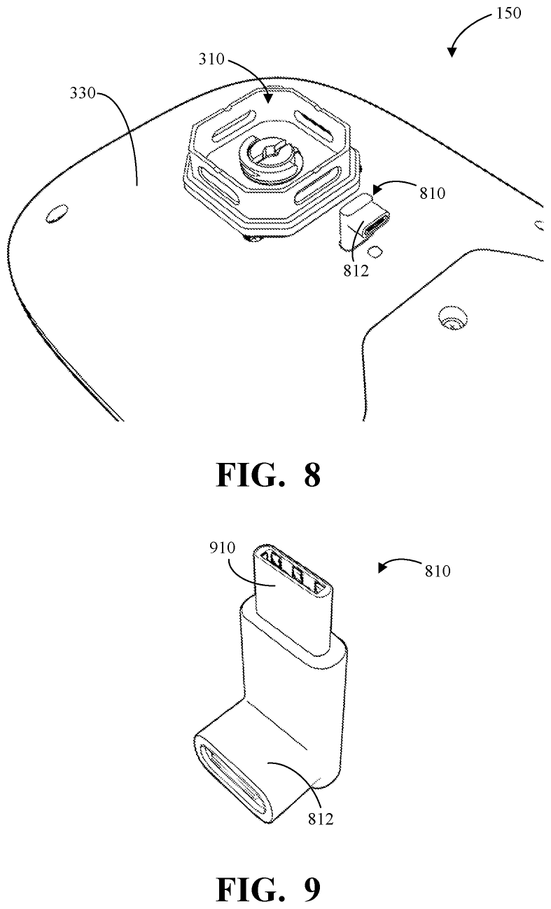

FIG. 8 illustrates a bottom view of the docking station 150. As discussed above, the upper member 310 of the mounting bracket 250 may be secured to the enclosure 330 of the docking station 150.

The enclosure 330 may form a bottom surface of the docking station 150 that opposes the landing surface 160. The enclosure 330 may provide a housing for one or more components of the docking station 150, such as components configured to charge the battery 140 of the UAV 100. Wiring or other electrical components may be located within the enclosure 330 to receive power from an external power source (e.g., a wall outlet via a power cord) and transfer such power to the battery 140 of the UAV 100 through the wiring or electrical components within the enclosure 330. The conducting contacts 180 located on the landing surface 160 may extend through the landing surface 160 to contact one or more components within the enclosure 330, such as a printed circuit board assembly (PCBA), to provide communication between the PCBA and the battery 140 of the UAV 100 when the UAV 100 is docked. As a result, utilizing the components located within the enclosure such as the PCBA, the battery 140 of the UAV 100 may be charged and the UAV 100 may be otherwise monitored or controlled.

To facilitate charging of the battery 140 of the UAV 100, an adapter 810 may be at least partially seeded in the enclosure 330. That is, the adapter 810 may be inserted into an opening or hole within the enclosure 330 to provide a connection between the internal circuitry and/or components of the docking station 150 (e.g., a battery charger) within the enclosure 330 and an outside power source. For example, the adapter 810 may include an input portion 812 configured to connect to a power cord or power adapter. The power cord or power adapter may be plugged into a wall outlet or may otherwise be connected to a power source (e.g., a generator, battery, direct wiring to a power grid, etc.) to receive the power from the power cord or power adapter and transfer the power via the internal circuitry and/or components of the docking station, thereby providing power to the UAV 100 to charge the battery 140.

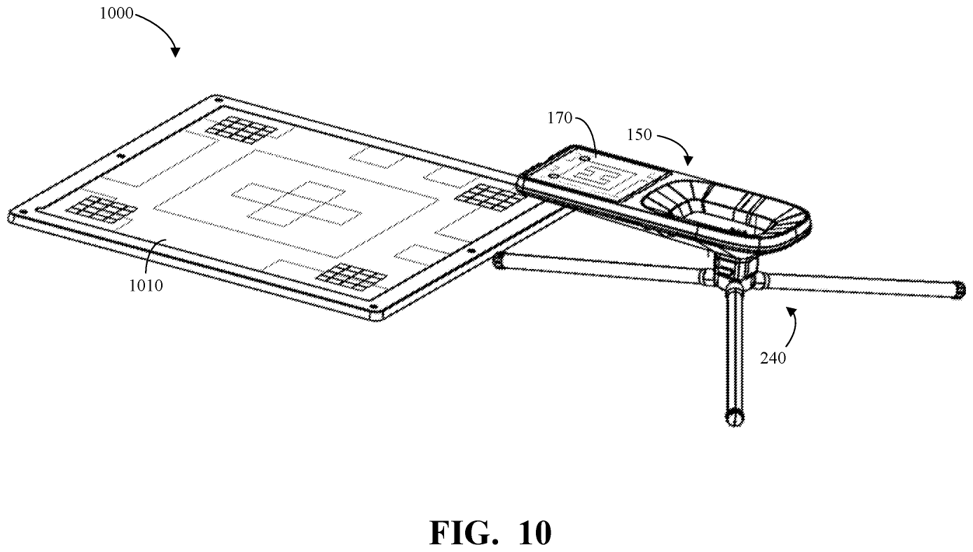

FIG. 9 illustrates a perspective view of the adapter 810 shown in FIG. 8. As discussed above, the adapter 810 may include an input portion 812 configured to receive power from an external source. Similarly, the adapter 810 may include an output portion 910 that is configured to communicate with the circuitry and/or electrical components of the docking station and disperse the power received from the input portion 812.

The input portion 812 and/or the output portion 910 may each be or may each include a connector. The connectors may be a pin connector, such as a universal serial bus (USB) connector (e.g., USB-A, USB-C, etc.) The connectors may be a converter to facilitate proper connection between the docking station 150 and the external power source. That is, the adapter 810 may facilitate proper distribution of the electrical power and may be configured to carry the desired voltage and/or current from the external power source.

Additionally, it should be noted that an overall geometry of the adapter 810 is not particularly limited. For example, the input portion 812 and the output portion 910 are shown in FIG. 9 to extend generally orthogonally to one another. However, the adapter 810 may also be substantially linear so that the input portion 812 and the output portion 910 are parallel or coaxial. Similarly, the adapter 810 may include on or more bends or elbows to accommodate various power sources.

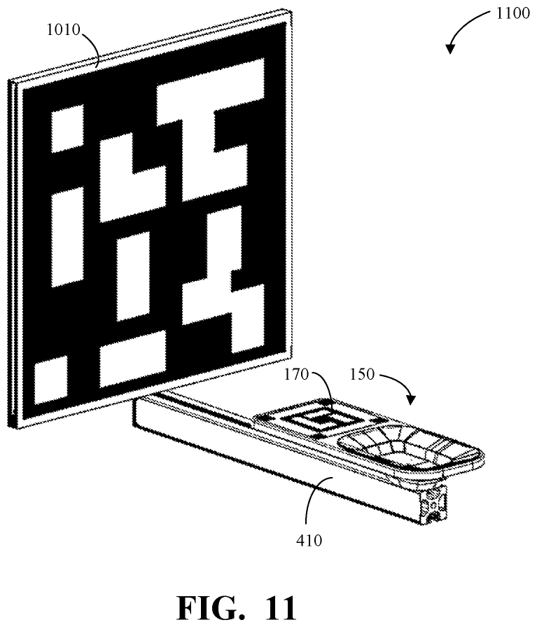

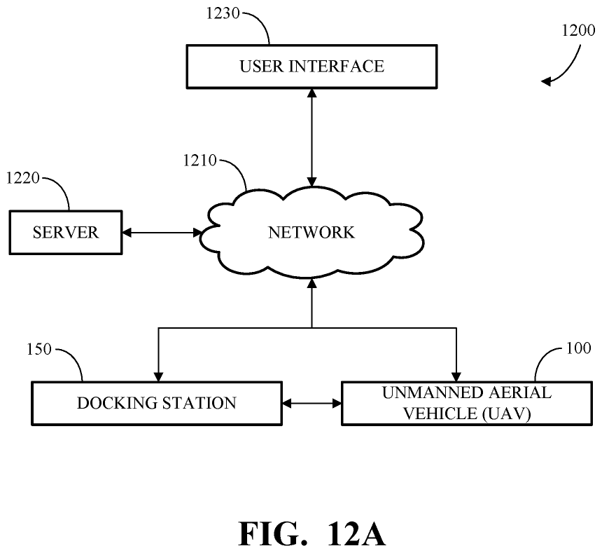

FIGS. 10 and 11 illustrate a perspective views of exemplary dock assemblies 1000 and 1100, respectively. As discussed above, the docking station 150 may be connected to a stand 240 and configured for freestanding use with the UAV 100, such as shown in the dock assembly 1000. Similarly, the docking station 150 may be connected to a mount 410 and configured for mounting to a surface or structure. As a result, the stand 240 or the mount 410 may support the docking station 150 to allow for landing (e.g., docking) of the UAV 100.

The UAV 100, as discussed above, may be configured for autonomous landing. During such a landing operation, the UAV 100 may use the image sensor 120 located on the UAV 100 to track and/or monitor images to identify the fiducial 170 located on the docking station 150. In doing so, the UAV 100 may utilize the fiducial 170 to identify a location of the docking station 150 and align the UAV 100 with the landing surface 160 of the docking station 150 to properly land (e.g., dock) the UAV 100.

In certain circumstances, an auxiliary fiducial 1010 may be incorporated into the dock assembly 1000. The auxiliary fiducial 1010 may be used in conjunction with the fiducial 170 located on the docking station 150. The auxiliary fiducial 1010 may have a similar or different pattern to that of the fiducial 170. For example, the auxiliary fiducial 1010 may have a different pattern and/or shape than the fiducial 170 so that the UAV 100 may distinguish between the fiducial 170 and the auxiliary fiducial 1010.

In certain embodiments, the auxiliary fiducial 1010 may aid with an approach of the UAV 100 towards the docking station 150. For example, depending on the distance or altitude between the UAV 100 and the docking station 150, the UAV 100 may be unable to identify the fiducial 170. As a result, the auxiliary fiducial 1010 may provide a significantly larger marker to be recognized by the UAV 100 (e.g., an area of the auxiliary fiducial 1010 may be greater than an area of the fiducial 170). The UAV 100 may first identify the auxiliary fiducial 1010 and begin an approach towards the general position of the auxiliary fiducial 1010. Once the UAV 100 has shortened the distance to the auxiliary fiducial 1010, the UAV 100 may then identify the fiducial 170 and begin its final descent to land (e.g., dock) on the docking station 150.

As such, it is envisioned that the auxiliary fiducial 1010 be positioned adjacent to or proximate to the docking station 150 to aid with guiding the UAV 100 during landing. However, in certain circumstances, a plurality of auxiliary fiducials 1010 may be located adjacent to and away from the docking station 150. For example, if the UAV 100 is configured for flight paths away from the docking station 150 to a location where the docking station 150 or general region of the docking station 150 is not visible, a plurality of auxiliary fiducials 1010 may be placed along the flight path of the UAV 100 to provide guidance back to the docking station 150.

A position of the auxiliary fiducial 1010 with respect to the fiducial 170 may vary. For example, as shown in FIG. 10, the auxiliary fiducial 1010 may be substantially parallel to the fiducial 170. The auxiliary fiducial 1010 may be positioned separate from the docking station 150 along a surface supporting the stand 240 (e.g., the floor of a building). Conversely, as shown in FIG. 11, the auxiliary fiducial 1010 may be positioned non-parallel (e.g., perpendicular) to the fiducial 170, whereby the auxiliary fiducial 1010 may be secured to or near the mount 410. As such, one skilled in the art may glean from the present teachings that a size, position, and/or shape of the auxiliary fiducial 1010 is not limited based on the above illustrations.

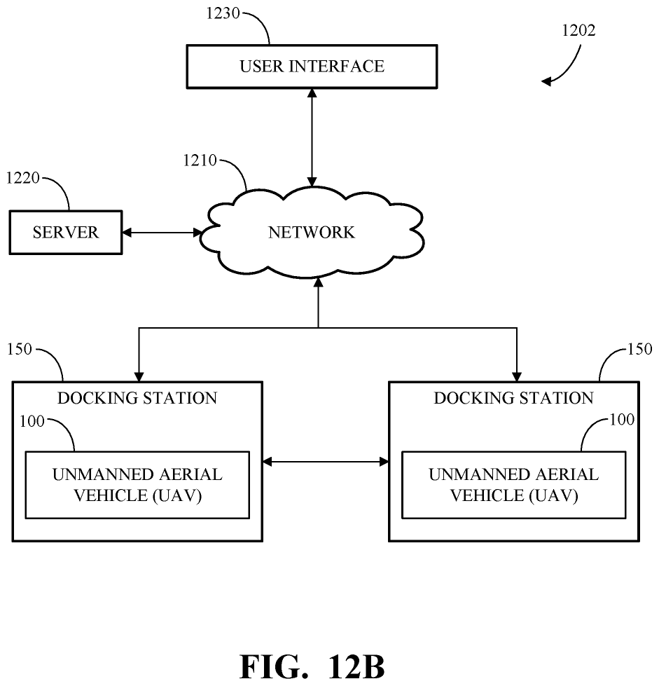

FIGS. 12A and 12B are diagrams 1200, 1202 of network configurations for a single UAV 100 and a pair of UAVs 100, respectively. In certain embodiments, it is envisioned that more than two UAVs 100 may be present. As such, the network configurations shown in FIGS. 12A and 12B may also apply to configurations with any number of UAVs 100.

With respect to FIG. 12A, the UAV 100 may be in communication with the docking station 150. As discussed above, the UAV 100 and the docking station 150 may be in contact with one another when the UAV 100 is docked. Due to such contact, the UAV 100 and the docking station 150 may establish communication to transfer data between the UAV 100 and the docking station 150. The UAV 100 and the docking station 150 may also establish wireless connection between one another, such that the docking station 150 may wirelessly transfer data to the UAV 100, or vice versa.

The UAV 100 may be controlled autonomously by one or more onboard processing aspects or remotely controlled by an operator. For example, an operator (e.g., a user) may control operation or otherwise communicate with the UAV 100 via a user interface 1230. The user interface 1230 may be an electronic device in which the user may interface with the UAV 100 before, during, or after flight of the UAV 100. The electronic device may be an electronic device that is remotely located from the UAV 100 and the docking station 150, such as, for example, a mobile phone, tablet, laptop, desktop, wireless controller, or a combination thereof.

The UAV 100 and the user interface 1230 may be in wireless communication

(e.g., wireless connection) via a network 1210 connection. The user interface 1230 may communicate with the UAV 100 via the network 1210 using a wireless communications link (e.g., a Wi-Fi network, a Bluetooth link, a ZigBee link, or another network or link). Additionally, it is envisioned that the user interface 1230 may communicate with the UAV 100 via a cloud-based network 1210 in which the user interface 1230 is located remotely from the UAV 100. In other words, the user interface 1230 may be located off-site from a location of the UAV 100 yet still wirelessly communicate with the UAV 100 via the cloud-based network 1210. To support the cloud-based connection between the user interface 1230 and the UAV 100, the user interface 1230 and/or the UAV 100 may also be in communication with a server 1220. The server 1220 may be remotely located and configured to store data for the user interface 1230 and/or the UAV 100. The server 1220 may communicate with the user interface 1230 and the UAV 100 via the cloud-based network 1210. As a result, the user interface 1230 and/or the UAV 100 may access data stored on the server 1220.

By way of example, the remote device as discussed above may access the server 1220 to establish the user interface 1230. The user interface 1230 may receive data from the server 1220 to establish one or more possible commands for the user. The executed commands from the user via the user interface 1230 may correlate to one or more actions of the UAV 100 (e.g., establish a designated flight path, establish a flight schedule, execute autonomous flight of the UAV 100, execute a software update of the UAV 100, etc.).

Similarly, the UAV 100 may access the server 1220 to transfer data to the server 1220 for access via the user interface 1230. For example, the UAV 100 may transfer flight data, operation data, error/fault data, or other data to the server 1220. As a result, the user may then access the data stored on the server 1220 via the user interface 1230.

As may be gleaned from the above examples, the cloud-based network 1210 may facilitate entirely remote communication between a user and the UAV 100 (e.g., via the user interface 1230). Therefore, the docking station 150 and the UAV 100 may only require an initial installation in-person and may thereafter be accessible offsite by the user.

It should also be noted that while a cloud-based communication has been discussed in detail above between the user interface 1230, the UAV 100, and the server 1220, the docking station 150 may also be in communication with the user interface 1230 and/or the server 1220 via the network 1210.

While a single UAV 100 has been discussed with respect to network communication, the above description may also apply to a system having more than one UAV 100 (e.g., two or more UAVs 100). By way of example, the diagram 1202 shown in FIG. 12B illustrates network communication for two UAVs 100 and their respective docking stations 150. Similar to the diagram 1200 of FIG. 12A, the diagram 1202 illustrates that both UAVs 100 and their respective docking stations 150 may be in communication with the user interface 1230 via the cloud-based network 1210. Additionally, the server 1220 may also be in communication with the user interface 1230, one or both of the docking stations 150, one or both of the UAVs 100, or a combination thereof.

Advantageously, the UAVs 100 may be in communication with one another. The UAVs 100 may be in wireless communication with one another via the network 1210. The UAVs 100 may be in communication with one another via a direct connection other than via the network 1210. For example, the UAVs 100 may communicate with one another directly via a Bluetooth connection or other type of direct wireless connection. As a result of the connection between the UAVs 100, the UAVs 100 may operate in a collaborative manner, as described further below.

Collaborative operation of the UAVs 100 may allow for the UAVs 100 to be, in certain circumstances, dependent on one another's actions. For example, a flight path of a first UAV 100 may dictate a flight path of the second UAV 100, or vice versa. The UAVs 100 may communicate data to one another to establish such a collaborative operation. The UAVs 100 may send data pertaining to one or more parameters (e.g., take off, landing, flight, current position, error/fault detection, alerts, etc.) so that each of the UAVs 100 may operate based upon the data sent. Similarly, such data may also be communicated to the user interface 1230 and/or the server 1220. Based on the above, the UAVs 100 may have real-time communication during operation to efficiently monitor or otherwise travel through a designated area without unneeded overlap in flight paths and without accidental collision.

The above network connections may include various engines, each of which may be constructed, programmed, configured, or otherwise adapted, to carry out a function or set of functions. The term engine as used herein means a tangible device, component, or arrangement of components implemented using hardware, such as by an application specific integrated circuit (ASIC) or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium, such as on the server 1220. Software residing in non-executable form may be compiled, translated, or otherwise converted to an executable form prior to, or during, runtime. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

Considering examples in which engines are temporarily configured, each of the engines may be instantiated at different moments in time. For example, where the engines comprise a general-purpose hardware processor core configured using software; the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers (e.g., the electronic device for the user interface 1230) that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any particular implementation exemplified herein, unless such limitations are expressly called out.

In addition, an engine may itself be composed of more than one sub-engines, each of which may be regarded as an engine in its own right. Moreover, in the embodiments described herein, each of the various engines corresponds to a defined functionality. However, it should be understood that in other contemplated embodiments, each functionality may be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Furthermore, the above functionality may be applicable to hardware and/or software of the user interface 1230 (e.g., the remote electronic device), the server 1220, the docking stations 150, and the UAVs 100.

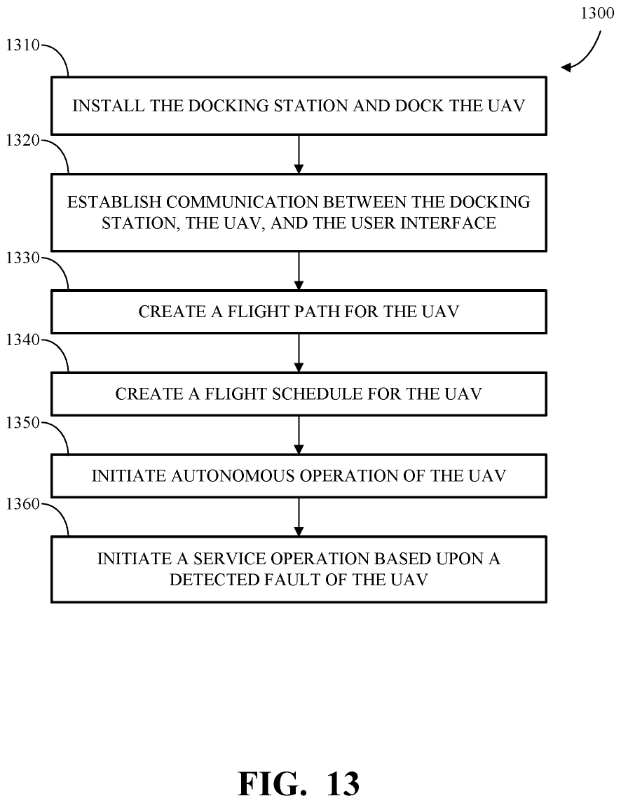

FIG. 13 illustrates a flowchart 1300 of an example process for initiating autonomous operation of the UAV 100. The process may be applicable to one or more UAV 100s. In other words, the process shown in the flowchart 1300 may be completed for a plurality of UAVs 100, such as the pair of UAVs 100 shown in FIG. 12B.

Initially, a user may install the docking station 150 and the UAV 100 at an operation 1310. Installation of the docking station 150 may be completed using the stand 240 or the mount 410 as discussed above. That is, a user may select a location to install the docking station 150 that may be proximate to an area that the UAV 100 may be configured to monitor or otherwise fly. Once installation of the docking station 150 is completed, the UAV 100 may be docked on the docking station 150.

After the operation 1310 is completed, network connection may be established at operation 1320. That is, communication may be established between the docking station 150, the UAV 100, and the user interface 1230 based on the diagrams 1200, 1202 shown in FIGS. 12A and 12B. Once such communication is established, a user may then communicate with the UAV 100 and/or the docking station 150 via the user interface 1230.

In the present example, the user may create a flight path for the UAV 100 at operation 1330 via the user interface 1230. The flight path may be established by the user so that the UAV 100 may monitor or otherwise travel via a designated area. The flight path may be entirely established by the user via the user interface 1230. However, in certain circumstances, the flight path may be autonomously or at least partially autonomously established using the UAV 100. For example, the user may initiate an initial training flight of the UAV 100 so that the UAV 100 may autonomously map out a designated area and determine an optimized flight path through the designated area, thereby eliminating the need for the user to manually enter the flight path. However, the present teachings are not limited to any specified flight path of the UAV 100, and creation of the flight path at the operation 1330 may include any configuration of travel for the UAV 100.

After the flight path has been created, the user may also create a flight schedule for the UAV 100 at operation 1340. The flight schedule may be created via the user interface 1230 similar to the flight path. The flight schedule may establish designated time(s) in which the UAV 100 will operate. The flight schedule may establish a reoccurring schedule for the UAV 100 to conduct flights. For example, the flight schedule may designate time(s) of day and day(s) of the week for the UAV 100 to complete flights.

After the flight path and flight schedule have been created, a user may initiate autonomous operation of the UAV 100 at operation 1350. Initiation of the autonomous operation may be done via the user interface 1230. Once the UAV 100 has been initiated to operate autonomously, the UAV 100 may complete autonomous flights based upon the created flight path and flight schedule. It should be noted, however, that a user may still communicate with the UAV 100 to initiate an unplanned flight or access real-time data (e.g., video feed, flight progress, etc.) while the UAV 100 is in operation.

Autonomous operation of the UAV 100 may be done for a variety of tasks. In certain circumstances, the UAV 100 may autonomously operate to complete inventory management within a structure or designated area. For example, the docking station 150 may be installed within a warehouse that contains various product inventory. The user may thus create a flight path at the operation 1330 in which the UAV 100 travels through the warehouse to monitor the product inventory (e.g., using one or more image sensors) on a routine basis based on the flight schedule created at the operation 1340. As a result, the UAV 100 may autonomously track the inventory of various items within the warehouse without the need for physical presence of the user onsite, thereby eliminating manhours and cost from the operation. The user may then access data from the UAV 100 via the user interface 1230 to review the inventory remotely and determine a course of action. For example, the user may access flight logs from the UAV 100 that are stored on the server 1220 to determine if inventory of one or more products has been depleted.

In another example, autonomous operation of the UAV 100 may be utilized for property management. A flight path and flight schedule may be created so that the UAV 100 may routinely fly through a designated area to determine a condition of a property. The property may be inside a structure or may be a designated area outside that requires management. In other words, the property need not be limited to any particular structure.

The UAV 100 may advantageously provide a way to easily and routinely monitor a property regardless of complexity. For example, in certain circumstances a complex property may need to be actively monitored in case of equipment failures or property damage. The property may be, but is not limited to, power utility stations and/or substations, warehouses, and oil rigs. In other circumstances, the property requiring monitoring may be a construction site (i.e., requiring monitoring of construction progress) or any other property not easily or conveniently accessible for human inspection. Based on these types of properties, the UAV 100 may advantageously conduct routine inspection to provide an initial assessment of any potential equipment failures or property damage, to determine progress on a construction site, or to conduct a general inspection for monitoring any possible issues. In any case, the UAV 100 may minimize or even eliminate the need for one or more individuals to physically access the property to conduct an inspection.

Therefore, one skilled in the art may glean from the present teachings that the process shown in the flowchart 1300 may be implemented for a variety of purposes. As a result, the process in the flowchart 1300 may provide a robust means to configure and autonomously operate the UAV 100. Additionally, it should be noted that in certain circumstances one or more of the operations may be done simultaneously or out of turn. For example, a flight schedule may be created before the flight path or communication between the docking station 150, the UAV 100, and the user interface 1230 may be established prior to installation of the docking station 150.

Additionally, the process may also include a service operation at operation 1360. The service operation 1360 may be completed at any point during autonomous operation of the UAV 100, before autonomous operation of the UAV 100, or after autonomous operation of the UAV 100. The service operation 1360 may be initiated based upon a detected fault of the UAV 100. One or more sensors or other components within the UAV 100 may actively or routinely monitor a condition of the UAV 100. If a fault in operation or functionality of the UAV 100 is detected, the UAV 100 may communicate the fault to the user via the user interface 1230. As a result, the user may be notified of a potential fault and may physically retrieve the UAV 100 to determine the issue.

In certain circumstances, the docking station 150 may be installed in a location that is difficult to physically reach (e.g., ceiling mounted, storage rack mounted out of reach, etc.). When the docking station 150 is located out of reach and the UAV 100 is docked on the docking station 150, the service operation 1360 may initiate flight of the UAV 100 along a service flight path. The service flight path may be a determined path for the UAV 100 to fly towards an accessible position for the user, such as the ground. As a result, the UAV 100 may be easily accessed by the user without requiring direct access to the docking station 150.

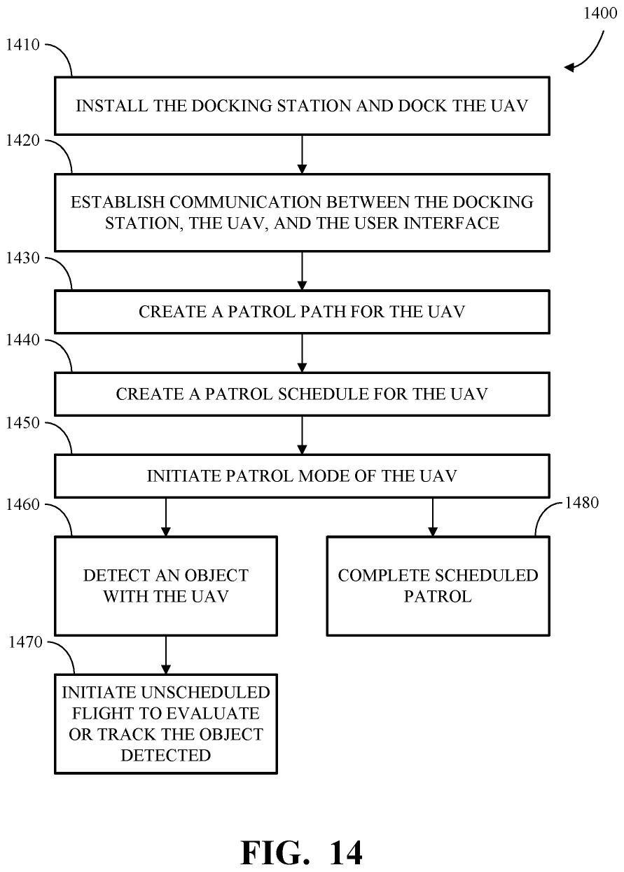

FIG. 14 illustrates a flowchart 1400 of an additional example process for initiating autonomous operation of the UAV 100. The process shown in the flowchart 1400 may, similar to the process shown in the flowchart 1300, include installation of the docking station 150 and docking of the UAV 100 at operation 1410. Such installation may once again be completed in accordance with the present teachings and various configurations discussed above.

Once installation of the docking station 150 and the UAV 100 is completed, communication may be established between the docking station 150, the UAV 100, and the user interface 1230. Communication may be established via a cloud-based network 1210, such as those described with respect to FIGS. 12A and 12B.

The UAV 100 may be configured for security protocols to monitor a designated area or structure for any potential hazards or dangers. As such, a user via the user interface 1230 may create a patrol path for the UAV 100 at operation 1430. The patrol path may be similar to the flight path discussed for the flowchart 1300. The patrol path may be a designated flight path of the UAV 100 to monitor specified locations within the structure or designated area for the potential hazards or dangers. For example, the UAV 100 may be configured to fly along the patrol path to actively monitor for potential intruders or any damaged items (e.g., active fire, broken windows and/or fences, broken items within a structure, etc.). Similar to the flight path discussed for the flowchart 1300, the patrol path created at the operation 1430 may be done manually by the user via the user interface 1230 or may be at least partially established using the UAV 100 (e.g., via an initial training flight).

Once the patrol path has been created, a patrol schedule may be created by the user via the user interface 1230 at operation 1440. The patrol schedule may be the designated schedule in which the UAV 100 is to complete patrols (e.g., flights) along the flight path. The patrol schedule may require that the UAV 100 complete a patrol at a specified interval during certain hours of the day. For example, the patrol schedule may require hourly patrol along the patrol path during nonworking hours in which nobody is present in the building (e.g., nighttime hours).

After the patrol path and the patrol schedule have been created, the user may initiate patrol mode of the UAV 100 via the user interface 1230. Patrol mode of the UAV 100 may activate autonomous operation of the UAV 100 to complete the routine patrols at operation 1480 along the patrol path. While the UAV 100 is in patrol mode, the UAV 100 may actively monitor the designated area along the patrol path and notify the user of any potential intruders or hazards at operation 1460. Notification may be provided actively from the UAV 100 to the user via the user interface 1230. Based upon such notifications, the user may access a video feed of the UAV 100 monitor a situation in real-time or may access stored data from the UAV 100 (e.g., flight data saved on the server 1220) to evaluate the situation.

The UAV 100 may also actively monitor the designated area between scheduled patrols. For example, the UAV 100 while in patrol mode may dock on the docking station 150 in between patrols. When docked, the UAV 100 may act as a security camera using one or more image sensors to provide a real-time video feed of the area visible by the UAV 100 from the docking station 150. A user may access the video feed in real-time via the user interface 1230 to continuously monitor the designated area. As a result, the UAV 100 may advantageously function as a security system that incorporates functionality of a convention security camera.

Similarly, it envisioned that when the UAV 100 is docked, the docking station 150 and the UAV 100 may be controlled by the user similar to a security camera. For example, the docking station 150 may be operable by the user via the user interface 1230 to move or otherwise articulate the docking station 150, thereby moving the UAV 100 to more robustly monitor the area around the docking station 150. The docking station 150 may include or be mounted to a gimbal or articulating arm that may be used in conjunction with the stand 240 and/or the mount 410 discussed above. As a result, a user may actively move the UAV 100 via the docking station 150 while the UAV 100 is docked so that the UAV 100 may function as a security camera.

During patrol mode, the UAV 100 may monitor the designated area (e.g., during a patrol flight and when docked) to detect one or more designated objects. The designated objects may include the hazards or intruders mentioned above. The user may define parameters via the user interface 1230 so that only specified objects are actively monitored by the UAV 100. For example, the user may establish that the UAV 100 monitor the designated area for moving objects, such as projectiles or intruders.

As discussed above, when the UAV 100 detects the designated objects at the operation 1460, notification may be provided to the user via the user interface to assess the situation. Additionally, the UAV 100 may be configured to follow or otherwise continuously monitor the designated objects when detected. For example, if an intruder is detected by the UAV 100, the UAV 100 may actively follow the intruder to maintain a visual and provide a live video feed of the intruder for the user. Following of the intruder may allow for the UAV 100 to travel off the designated patrol path. Similarly, the UAV 100 may autonomously initiate flight at operation 1470 if the intruder was detected when the UAV 100 is docked so that the UAV 100 may follow the intruder during an unscheduled flight.

In certain configurations, a plurality of UAVs 100 may be in communication as shown in FIG. 12B. The UAVs 100 may establish communication with one another at the operation 1420 to create a collaborative regiment of UAVs 100 for security patrol. Each of the UAVs 100 may have a designated patrol path and patrol schedule. The patrol paths and schedules may be similar or different. For example, a first UAV 100 may have a first patrol path for patrol on a designated schedule and a second UAV 100 may have a second patrol path that is different from the first patrol path for patrol on the same designated schedule as the first UAV 100. As a result, the first and the second UAVs may conduct synchronous patrols of adjacent, but distinct areas along their respective patrol paths.

Advantageously, communication between the UAVs 100 may provide more robust monitoring of the designated structure or area. If an object, such as an intruder, is detected by a first UAV 100 in a first designated area, the first UAV 100 may follow the intruder within the first designated area until the intruder moves outside of the first designated area. However, a second UAV 100 located within the second designated area may communicate with the first UAV 100 to continue active monitoring (e.g., following) of the intruder within the second designated area. As a result, even if one UAV 100 were to lose visibility of an intruder due to the intruder being out of range, another UAV 100 may pick up tracking of the intruder. Therefore, a plurality of UAVs 100 may be strategically positioned throughout a structure or designated area to ensure monitoring of all desired areas.

Based on the above, it is envisioned that a plurality of UAVs 100 may provide a dynamic security system that facilitates active monitoring and tracking of potential risks or hazards within a designated area. The UAVs 100, when in the patrol mode, may be configured for both docked security monitoring and security monitoring during flight. As discussed above, the UAVs 100 and the docking station 150, when docked, may be remotely controllable by a user via the user interface 1230 or another remote device. Similarly, if a plurality of docked UAVs 100 are in communication with one another, the user may remotely control the UAVs 100 and their respective docking stations 150 as well as monitor a live video stream of each of the UAVs 100. For example, the user interface 1230 may provide a “tiled” interface where each UAV 100 provides a video stream for a respective tile being shown on the user interface 1230. However, transmittal of the video feeds from the UAVs 100 is not limited to any one display technique.

Advantageously, based on the aforementioned UAVs 100 providing live video feeds to the user via the user interface 1230, the user may actively monitor the video feeds for any objects in question. As mentioned above, the UAVs 100, when in patrol mode, may autonomously detect a designated object and monitor and/or track the designated object based on predefined parameters. However, the user, via the user interface 1230, may also interact with each of the UAVs 100 when in patrol mode. If the user identifies an object (e.g., an intruder) on the live video feed from one of the UAVs 100, the user may interface with the user interface 1230 to initiate the UAV 100 taking flight and actively tracking the identified object. For example, the user interface 1230 may facilitate the user physically touching the identified object in the video feed, whereby the UAV 100 thereafter begins to track the identified object. Similarly, it should be noted that one or more additional UAVs 100 may also automatically and dynamically launch and/or track the identified object to ensure that the identified objection is unable to escape the view of the UAVs 100 within a designated environment or area. During such tracking, the UAVs 100 may maintain and continuously provide the live video feed to the user interface 1230. As a result, one skilled in the art may understand from the present teachings that a group of the UAVs 100 in communication with one another may provide a more robust and dynamic security system in which an identified object may be continuously monitored to eliminate the risk of losing sight of the identified object.

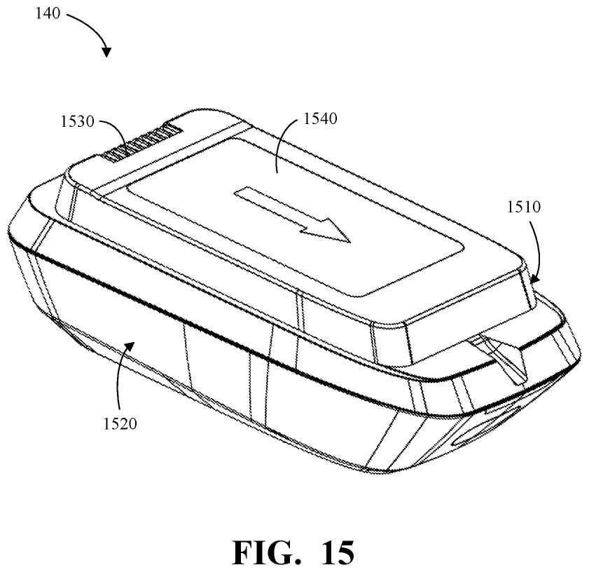

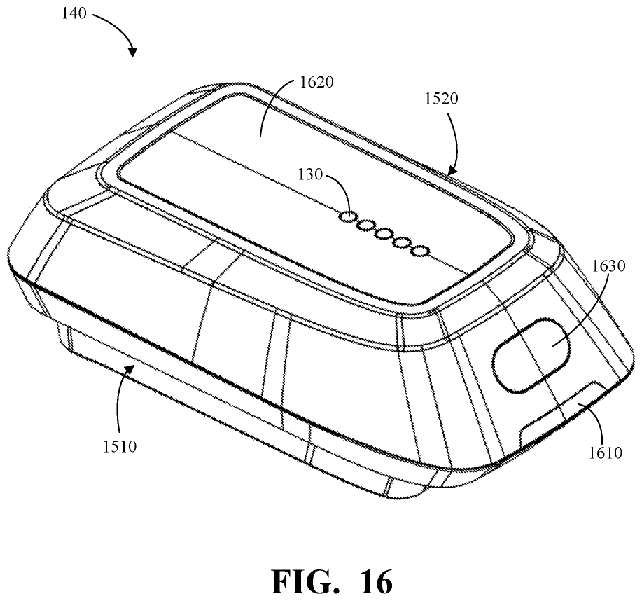

FIGS. 15 and 16 illustrate a top perspective view and a bottom perspective view, respectively, of an exemplary battery 140 for the UAV 100. The battery 140 may have an enclosure configured to house one or more components of the battery 140, such as but not limited to: one or more power modules (e.g., battery cells), electronic circuitry, lights, user interfaces, or a combination thereof. The enclosure may be a housing or casing of the battery 140 that forms an overall geometry of the battery 140. The enclosure may be configured to contact the UAV 100, the docking station 150, or both. The enclosure of the battery 140 may have openings, apertures, slots, grooves, ridges, ribs, or a combination thereof.

The enclosure may include an upper portion 1510 and a lower portion 1520. The upper portion 1510 and the lower portion 1520 may be coupled to each other. The upper portion 1510 and the lower portion 1520 may be connected to each other using a mechanical interlock, one or more fasteners, an adhesive, or a combination thereof. In certain configurations, the upper portion 1510 and the lower portion 1520 may be monolithically formed with each other.

The upper portion 1510 may be configured to contact the UAV 100. The upper portion 1510 may include a contact surface 1540 that is configured to contact or otherwise engage a portion of the UAV 100. For example, the UAV 100 may include a region configured to receive the contact surface 1540 to connect the battery 140 to the UAV 100. The contact surface 1540 may be any size or shape. The contact surface 1540 may be complimentary in shape to the region of the UAV 100 receiving the contact surface 1540.

The contact surface 1540 may include an engagement region 1530. The engagement region 1530 may be configured to engage with one or more components of the UAV 100 to facilitate transfer of power from the battery 140 to the UAV 100. The engagement region 1530 may include one or more conducting contacts (e.g., pins, slot, fins, etc.) that contact the electronic components of the UAV 100. The engagement region 1530 may include one or more conducting contacts that are the same as, or different from, the conducting contacts 130, 180. Advantageously, the engagement region 1530 may releasably engage the electronic components of the UAV 100 to facilitate disconnection between the battery 140 and the UAV 100.

The contact surface 1540 of the upper portion 1510 may also facilitate releasable connection between the battery 140 and the UAV 100. For example, the contact surface 1540 may magnetically engage the UAV 100 to connect the battery 140 to the UAV 100. As a result, the magnetic connection may be sufficient to maintain connection between the battery 140 and the UAV 100 during operation of the UAV 100, yet the battery 140 may be easily released from the UAV 100 if needed (e.g., for charging of the battery 140 separate from the UAV 100).

In certain embodiments, the contact surface 1540 may engage the UAV 100 in a manner other than magnetic connection. For example, the contact surface 1540 may include a mechanical interlock that engages the UAV 100, whereby the mechanical interlock may be manually released by a user to disconnect the battery 140 from the UAV 100.

As discussed above, the upper portion 1510 of the enclosure of the battery 140 may be coupled to the lower portion 1520. The lower portion 1520 may be configured to engage the docking station 150. For example, as discussed with respect to FIG. 1, the lower portion 1520 may be configured to contact or otherwise engage the landing surface 160 of the docking station 150.

The lower portion 1520 may be similar in shape to the upper portion 1510 or may have a different geometry. The lower portion 1520 may be complimentary in shape to the docking station 150. The lower portion 1520 may be complimentary in shape to the landing surface 160 of the docking station 150. For example, the lower portion 1520 may include a taper or funnel-like region the is complimentary in shape to a taper or funnel-like region of the landing surface 160.

The lower portion 1520 may include a bottom surface 1620. The bottom surface 1620 may be a surface of the enclosure of the battery 140 that is configured to contact the landing surface 160 and/or be supported by the landing surface 160 when the UAV 100 is docked on the docking station 150. The bottom surface 1620 may be complimentary in shape to a portion of the landing surface 160, such as the base 162 of the landing surface 160. For example, the bottom surface 1620 and the base 162 may both be substantially planar so that the bottom surface 1620 is substantially flush with the base 162 when the UAV 100 is docked. In certain configurations, the bottom surface 1620 may be substantially parallel to the contact surface 1540 of the upper portion 1510 of the enclosure. However, the bottom surface 1620 and the contact surface 1540 may form any angle relative to each other.

As discussed above, the battery 140 may include one or more conducting contacts 130 configured to engage the conducting contacts 180 (e.g., pogo pins) of the docking station 150. The conducting contacts 130 may be located or otherwise disposed on the lower portion 1520 of the enclosure of the battery 140. The conducting contacts 130 may be located on the bottom surface 1620 of the lower portion 1520. The conducting contacts 130 may be arranged in any desired manner or pattern along the bottom surface 1620 so that the conducting contacts 130 may contact respective conducting contacts 180 located on the docking station. For example, the conducting contacts 130 may be arranged in one or more substantially linear arrays so that the conducting contacts 130 align with one or more substantially linear arrays formed by the conducting contacts 180 of the docking station 150. However, in certain embodiments, the conducting contacts 130 may be arranged in patterns other than linear arrays, such as spaced apart along a perimeter of the bottom surface 1620 of the lower portion 1520.

The battery 140 may also include a light 1610. The light 1610 may be disposed or located on the upper portion 1510 or the lower portion 1520 of the enclosure of the battery 140. For example, as shown in FIG. 16, the light 1610 may be located on the lower portion 1520 of the enclosure on a surface non-parallel to the bottom surface 1620. However, the light 1610 is not limited to a particular location along the battery 140. It is envisioned that the light 1610 may be disposed on the battery 140 in a location that may be visible when the battery 140 is connected to the UAV 100, when the UAV 100 is docked on the docking station 150, or both.

The light 1610 may function as an indicator light for the battery 140. The light 1610 may indicate a status of the battery 140, a status of the UAV 100, or both. The light 1610 may indicate whether the battery 140 is charging, whether the battery 140 is turned on (e.g., providing power to the UAV 100), whether the battery 140 is turned off (e.g., not providing power to the UAV 100), whether the battery 140 is defective (e.g., can no longer hold a charge), a charge level of the battery 140, other statuses of the battery 140, or a combination thereof. The light 1610 may also include one or more colors (e.g., may include one or more light emitting diodes (LEDs)) that may be configured to indicate certain statuses of the battery 140, the UAV 100, or both.

The battery 140 may also include a control 1630. The control 1630 may be located along the enclosure on the upper portion 1510 or the lower portion 1520 of the enclosure. The control 1630 may be located near or adjacent to the one or more conducting contacts 130 of the battery 140, the light 1610, or both. For example, the control 1630 may be located between the conducting contacts 130 and the light 1610 on the lower portion 1520 of the enclosure. The control 1630 may protrude from an exterior surface of the enclosure, may be recessed from the exterior surface of the enclosure, or may be substantially flush with the exterior surface of the enclosure.

The control 1630 may be a button or sensor configured to receive an input from a user of the UAV 100. The control 1630 may be a mechanical button or a contact region along the enclosure. The control 1630 may be a capacitive touch sensor, motion sensor, or other type of sensor. As a result, the control 1630 may facilitate input from the user to modify a state of the battery 140. For example, the user may press or touch the control 1630 to turn the battery 140 on and off, may press or touch the control 1630 to sync the battery 140 to a device (e.g., the docking station 150 and/or the UAV 100 using one or more wireless connection components within the battery 140), or both.

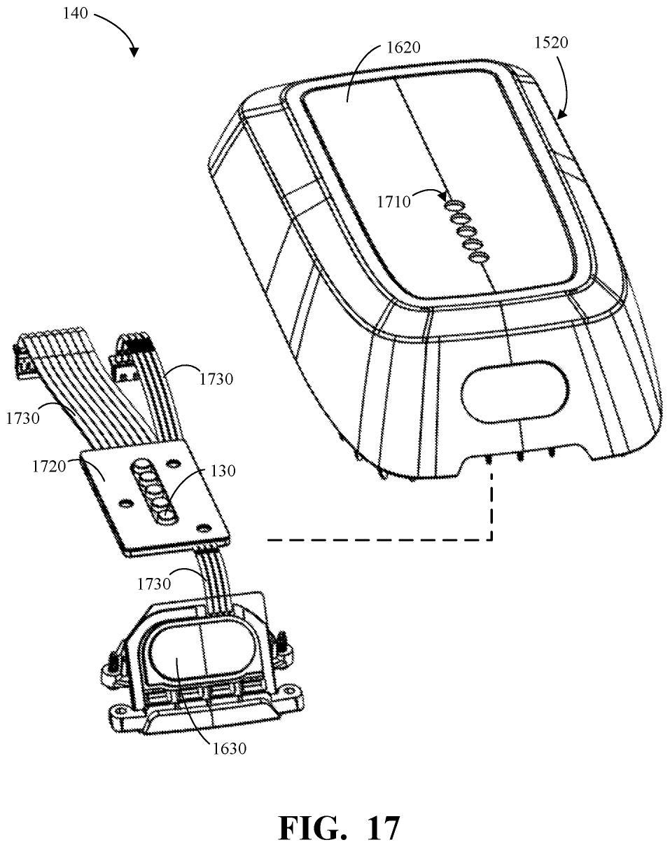

FIG. 17 illustrates an exploded view of the battery 140 described above. As discussed above, the battery 140 may include the upper portion 1520 coupled to the lower portion 1510 to enclose one or more electronic components of the battery 140.

As shown in FIG. 17, the lower portion 1520 may include one or more apertures 1710. The apertures 1710 may be located on the bottom surface 1620 of the lower portion 1520. The apertures 1710 may be configured to receive the conducting contacts 130 of the battery 140 so that the conducting contacts 130 extend through the apertures 1710 to be substantially flush with the bottom surface 1620, thereby facilitating contact between the conducting contacts 130 and the conducting contacts 180 of the UAV 100.

The conducting contacts 130 may also be in communication or otherwise coupled to the electronic components located within the enclosure of the battery 140, such as a printed circuit board assembly (PCBA) 1720. Due to such connection, the conducting contacts 130 may provide an electrical connection between the battery charger of the docking station 150 and the one or more power modules (e.g., battery cells) of the battery 140. For example, the conducting contacts 130 may receive power from the battery charger of the docking station 150 through the conducting contacts 180 of the docking station 150, whereby the conducting contacts 130 may be in communication with the one or more power modules to charge the one or more power modules via the PCBA 1720, one or more connectors 1730 of the battery 140, or a combination thereof.

Additionally, it should be noted that the control 1630 of the battery 140 may be in communication with the electrical components of the battery 140 (e.g., the PCBA 1720, the conducting contacts 130, the one or more power modules, or a combination thereof) via the connectors 1730. As a result, the user may operate or toggle a state of the battery 140 by the control 1630. The connectors 1730 may include wiring, a casing for the wiring, or both. The connectors 1730 may also include one or more clips or adapters to connect the electrical components to one another.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

Persons skilled in the art will understand that the various embodiments of the present disclosure and shown in the accompanying figures constitute non-limiting examples, and that additional components and features may be added to any of the embodiments discussed hereinabove without departing from the scope of the present disclosure. Additionally, persons skilled in the art will understand that the elements and features shown or described in connection with one embodiment may be combined with those of another embodiment without departing from the scope of the present disclosure to achieve any desired result and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the present disclosure, as are alternative embodiments that may result from combining, integrating, and/or omitting features from any of the disclosed embodiments.

Use of the term “optionally” with respect to any element of a claim means that the element may be included or omitted, with both alternatives being within the scope of the claim. Additionally, use of broader terms such as “comprises,” “includes,” and “having” should be understood to provide support for narrower terms such as “consisting of,” “consisting essentially of,” and “comprised substantially of” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” “horizontal,” “vertical,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°±25% (e.g., an angle that lies within the range of (approximately) 135° to (approximately)225°). The term “generally parallel” should thus be understood as referring to encompass configurations in which the pertinent components are arranged in parallel relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A battery configured to removably engage an unmanned aerial vehicle, comprising:
an enclosure configured to removably couple, both structurally and electrically, to an underside of the unmanned aerial vehicle, the enclosure having:
an upper portion configured to magnetically couple to the underside of the unmanned aerial vehicle;
a lower portion coupled to the upper portion and configured to contact a landing surface of a docking station of the unmanned aerial vehicle, wherein the lower portion is complimentary in shape to the landing surface;
an interior space formed and at least partially surrounded by the upper portion and the lower portion;
one or more power modules arranged substantially within the interior space;
one or more light emitting diodes disposed on the enclosure and configured to visually indicate a status of the unmanned aerial vehicle, the battery, or both; and
one or more conducting contacts disposed on the lower portion of the enclosure and configured to compressibly engage one or more pogo pins of the docking station to charge the one or more power modules.

2. The battery of claim 1, wherein the one or more conducting contacts are configured to contact and compress the one or more pogo pins of the docking station when the unmanned aerial vehicle is docked on the docking station.

3. The battery of claim 2, wherein the one or more conducting contacts are substantially flush with an exterior surface of the lower portion of the enclosure and extend through the enclosure into the interior space to couple directly or indirectly with the one or more power modules.

4. The battery of claim 3, wherein the one or more conducting contacts are located in apertures of the lower portion; and
wherein the one or more conducting contacts extend through the apertures to contact a printed circuit board assembly disposed in the interior space of the enclosure.

5. A system, comprising:
an unmanned aerial vehicle including:
a propulsion mechanism; and
a battery coupled to a bottom portion of the unmanned aerial vehicle that includes one or more conducting contacts extending through an enclosure of the battery; and
a docking station that includes one or more pogo pins configured to contact the one or more conducting contacts of the battery to charge the battery when the unmanned aerial vehicle is docked on the docking station.

6. The system of claim 5, wherein the one or more conducting contacts are configured to compressibly engage the one or more pogo pins of the docking station to establish an electrical connection between the battery and a battery charger disposed in an interior space of the docking station.

7. The system of claim 5, wherein the one or more pogo pins are located on a landing surface of the docking station; and
wherein the one or more conducting contacts are located on a portion of the enclosure of the battery that is configured to contact the landing surface.

8. The system of claim 7, wherein the one or more conducting contacts are located within apertures of the enclosure extending through a thickness of a wall of the enclosure; and
wherein the one or more conducting contacts are substantially flush with an exterior surface of the enclosure.

9. The system of claim 8, wherein the one or more conducting contacts include at least one substantially linear array of conducting contacts disposed in at least one substantially linear array of apertures of the enclosure.

10. The system of claim 5, wherein the enclosure of the battery includes:
an upper portion having a contact surface configured to contact the unmanned aerial vehicle and magnetically couple to an underside of the unmanned aerial vehicle; and
a lower portion coupled to the upper portion and having a bottom surface configured to contact the docking station, wherein the one or more conducting contacts are located on the bottom surface.

11. The system of claim 10, wherein the bottom surface of the lower portion is substantially parallel to the contact surface of the upper portion; and
wherein the lower portion is complimentary in shape to a landing surface of the docking station.

12. The system of claim 10, wherein the upper portion includes an engagement region configured to mechanically and electrically engage the unmanned aerial vehicle to transfer power from the battery to the unmanned aerial vehicle.

13. The system of claim 5, wherein the battery includes a control disposed along an exterior surface of the enclosure; and
wherein the control is electrically coupled to one or more power modules located within the enclosure of the battery.

14. The system of claim 13, wherein the battery includes a light configured to visually indicate a status of the unmanned aerial vehicle, the battery, or both; and
wherein the light is disposed on the exterior surface of the enclosure adjacent to the control.

15. The system of claim 5, wherein the enclosure forms an interior space of the battery that houses one or more power modules configured to power the unmanned aerial vehicle; and
wherein the one or more power modules are configured to electrically couple with a battery charger of the docking station via the one or more conducting contacts contacting the one or more pogo pins.

16. The system of claim 5, wherein the enclosure includes a substantially planar surface configured to contact a substantially planar landing surface of the docking station when the unmanned aerial vehicle is docked on the docking station; and
wherein the one or more conducting contacts are disposed on the substantially planar surface of the enclosure along a longitudinal axis of the battery.

17. The system of claim 5, wherein the one or more conducting contacts are coupled to a printed circuit board assembly that is disposed in an interior cavity of the enclosure and mounted to an interior surface of the enclosure.

18. The system of claim 17, wherein the printed circuit board assembly is electrically coupled to one or more power modules disposed in the interior cavity; and
wherein the printed circuit board assembly is electrically coupled to a control of the battery configured to control a state of the battery.

19. The system of claim 18, wherein the printed circuit board assembly is electrically coupled to one or more light emitting diodes of the battery that are configured to receive power from the one or more power modules and visually indicate a status of the battery.

20. A battery configured to power an unmanned aerial vehicle, comprising:
an enclosure configured to house a power module of the battery; and
one or more conducting contacts located on the enclosure configured to contact one or more pogo pins of a battery charger located on a docking station of the unmanned aerial vehicle.
